(19) United States
(12) Patent Application Publication
(10) Pub. No.: US 2025/0112551 A1
(43) Pub. Date: Apr. 3, 2025

(54) HANDLING SURGE OF CURRENT DUE TO A SUDDEN INCREASE IN OPERATION LOAD

(71) Applicant: International Business Machines Corporation, Armonk, NY (US)

(72) Inventors: Takeo Yasuda, Nara-Shi (JP); Atsuya Okazaki, Setagaya-Ku (JP)

(21) Appl. No.: 18/374,110

(22) Filed: Sep. 28, 2023

(51) Int. Cl. H02M 3/157; H02M 1/00; H02M 1/34; H02M 3/156

(52) U.S. Cl. CPC H02M 3/157; H02M 1/0045; H02M 1/342; H02M 3/1566

(57) ABSTRACT

A computer-implemented method, system, and computer program product for handling a surge of current due to a sudden increase in operation load. A task is scheduled to be executed, where the task only includes a real load. Upon executing the task, it is determined if the amount of the current change radio caused by the real load exceeds a threshold value within a period of time. If the amount of the current change ratio is predicted to exceed the threshold value within the period of time, a predicted rush current (surge of current) may be said to occur. In response to predicting a potential rush current, a dummy load is added in the high-power multi-voltage system or a dummy sink current is added to an output of the switching regulator of the power module in order to reduce the amount of the current change ratio.

### TECHNICAL FIELD

The present disclosure relates generally to power supply systems, and more particularly to handling a surge of current (referred to herein as the “rush current”) caused by a sudden increase in the operation load.

### BACKGROUND

A power supply system is a system that includes an electrical device that supplies electric power to an electrical load. The main purpose of a power supply is to supply enough current at the correct voltage for correct operation in the target system or chip. For example, a power supply system may supply power to a high-power multi-voltage system that includes components, such as an analog or a custom digital signal processor, analog or digital memory circuits, etc.

Such power supply systems may include a power module which provides the physical containment for several power components, such as switching regulators (e.g., DCDC switching regulators) and low-dropout (LDO) regulators. A switching regulator, such as a DCDC switching regulator, converts input direct current (DC) voltage to the desired direct current (DC) voltage. A LDO regulator is a DC linear voltage regulator that regulates the output voltage even when the input voltage is very close to the output voltage.

Multiple regulators, such as switching regulators and LDO regulators, may be placed close to the processor chips or modules in order to meet the processor's requirement (e.g., low noise margin, high rush current, etc.) for point of load (POL). Point of load (POL) power supplies solve the challenge of high peak current demands and low noise margins required by high-performance semiconductors, such as microcontrollers or ASICs, by placing individual power supply regulators (linear or DCDC) close to their point of use.

In order to implement a large current power supply system to supply power to a high-power multi-voltage system, the power module of the power supply system needs to utilize multiple regulators, such as the regulators discussed above, in order to implement POL for power distribution, save space for multiple power supplies and enable system portability.

In certain situations, the power module of the power supply system needs to handle a surge of current (referred to herein as the “rush current”) due to a sudden increase in operation load, such as a sudden increase in the load exhibited by the high-power multi-voltage system.

Such a surge of current may not be able to be handled by only the power module. For example, the de-coupling capacitor (capacitor used to decouple one part of a circuit from another) may not be able to maintain the correct voltage level to power the load. Furthermore, rush current may cause a malfunction in the power module, such as with the switching regulators (e.g., DCDC switching regulators) due to the saturation of the inductors or the destruction of the power switches. Furthermore, the malfunction of the switching regulators (e.g., DCDC switching regulators) may then cause operation problems for the LDO regulators due to having their input voltage and current supplied by such switching regulators.

Unfortunately, there is not currently a means for effectively handling such surges of current (rush currents) by the power module due to a sudden increase in operation load.

### SUMMARY

In one embodiment of the present disclosure, a computer-implemented method for handling a surge of current due to a sudden increase in operation load comprises scheduling a task to be executed, where the task comprises a real load. The method further comprises adding a dummy load in a high-power multi-voltage system or a dummy sink current to an output of a switching regulator of a power module to reduce an amount of a current change ratio in response to the executed task indicating an amount of the current change ratio exceeding a threshold value within a period of time.

Furthermore, in one embodiment of the present disclosure, the method additionally comprises generating code to include both the real load and a dummy load.

Additionally, in one embodiment of the present disclosure, the code is executed so that compensated current which includes current for both the real load and the dummy load is pulled from the output of the switching regulator of the power module.

Furthermore, in one embodiment of the present disclosure, the switching regulator comprises a DCDC switching regulator.

Additionally, in one embodiment of the present disclosure, the method further comprises generating control signals to add the dummy sink current to the output of the switching regulator of the power module.

Furthermore, in one embodiment of the present disclosure, the control signals are used to instruct a programmable electrical load to pull the dummy sink current from the output of the switching regulator of the power module to reduce the amount of the current change ratio.

Additionally, in one embodiment of the present disclosure, the control signals are used to instruct a switching device to pull the dummy sink current from the output of the switching regulator of the power module to reduce the amount of the current change ratio.

Other forms of the embodiments of the computer-implemented method described above are in a system and in a computer program product.

In this manner, the rush current may now be handled by a power module, a high-power multi-voltage system, and a power supply controller by adding a dummy load in the program memory of the high-power multi-voltage system or by adding a dummy sink current directly to an output of a switching regulator (e.g., DCDC switching regulator) of the power module to reduce the amount of the current change ratio prior to the sudden increase in operation load. The reduction of the current change ratio is accomplished without system latency degradation (i.e., without delaying and reducing the load but instead by imposing an additional dummy load or dummy sink current).

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates reducing the amount of the current change ratio based on prediction by placing an additional dummy load into the high-power multi-voltage system before processing the real operation load in accordance with an embodiment of the present disclosure;

FIG. 3 illustrates a structure to achieve the amount of current change ratio reduction based on prediction by adding a dummy load into the high-power multi-voltage system before the sudden increase in the operation load in accordance with an embedment of the present disclosure;

FIG. 4 illustrates the total loads for the amount of the current change ratio reduction for a certain period based on prediction by utilizing a dummy load assignment in accordance with an embodiment of the present disclosure;

FIG. 5 illustrates reducing the amount of the current change ratio based on prediction by adding dummy sink current to the power module before processing the real operation load in accordance with an embodiment of the present disclosure;

FIG. 6 illustrates adding the dummy sink current to the output of the switching regulator based on prediction by using a programmable electrical load in order to reduce the amount of the current change ratio before the sudden increase in the operation load in accordance with an embodiment of the present disclosure;

FIG. 7 illustrates adding the dummy sink current to the output of the switching regulator based on prediction by using a current controlled-switch in order to reduce the amount of the current change ratio before the sudden increase in the operation load in accordance with an embodiment of the present disclosure;

FIG. 8 illustrates the compensated current for the amount of the current change ratio reduction by adding the dummy sink current based on prediction bin accordance with an embodiment of the present disclosure;

FIG. 9 illustrates an embodiment of the present disclosure of the hardware configuration of the power supply controller which is representative of a hardware environment for practicing the present disclosure;

FIG. 10 is a flowchart of a method for handling a surge of current by the power module, the high-power multi-voltage system, and the power supply controller due to a sudden increase in the operation load based on prediction by adding a dummy load in accordance with an embodiment of the present disclosure;

FIG. 11 is a flowchart of a method for handling a surge of current by the power module, the high-power multi-voltage system, and the power supply controller due to a sudden increase in the operation load based on prediction by adding a dummy sink current directly to an output of the switching regulator of the power module in accordance with an embodiment of the present disclosure;

FIG. 12 is a flowchart of a method of a dynamic control scheme for handling a surge of current by the power module, the high-power multi-voltage system, and the power supply controller due to a sudden increase in the operation load based on prediction by adding a dummy load in accordance with an embodiment of the present disclosure; and

FIG. 13 is a flowchart of a method of a dynamic control scheme for handling a surge of current by the power module, the high-power multi-voltage system, and the power supply controller due to a sudden increase in the operation load based on prediction by adding a dummy sink current directly to an output of the switching regulator of the power module in accordance with an embodiment of the present disclosure.

### DETAILED DESCRIPTION

In one embodiment of the present disclosure, a computer-implemented method for handling a surge of current due to a sudden increase in operation load comprises scheduling a task to be executed, where the task comprises a real load. The method further comprises adding a dummy load in a high-power multi-voltage system or a dummy sink current to an output of a switching regulator of a power module to reduce an amount of a current change ratio in response to the executed task indicating an amount of the current change ratio exceeding a threshold value within a period of time.

In this manner, the rush current may now be handled by adding a dummy load into the high-power multi-voltage system or adding a dummy sink current to an output of the switching regulator (e.g., DCDC switching regulator) of the power module to reduce the amount of the current change ratio. The reduction of the current change ratio is accomplished without system latency degradation (i.e., without delaying and reducing the load but instead by imposing an additional dummy load or dummy sink current).

Furthermore, in one embodiment of the present disclosure, the method additionally comprises generating code to include both the real load and a dummy load.

In this manner, the dummy load code can be added into the program memory in the high-power multi-voltage system.

Additionally, in one embodiment, the code is executed so that compensated current, which includes current for both the real load and the dummy load, is pulled from the output of the switching regulator of the power module.

In this manner, code that includes both the real load and the dummy load can be executed so that compensated current which includes current for executing both the real load and the dummy load can be pulled from the output of the switching regulator of the power module.

Furthermore, in one embodiment, the switching regulator comprises a DCDC switching regulator.

In this manner, the switching regulator may correspond to a DCDC switching regulator.

Additionally, in one embodiment, the method further comprises generating control signals to add the dummy sink current to the output of the switching regulator of the power module.

In this manner, dummy sink current can be added to the output of the switching regulator of the power module using control signals.

Furthermore, in one embodiment, the control signals are used to instruct a programmable electrical load to pull the dummy sink current from the output of the switching regulator of the power module to reduce the amount of the current change ratio.

In this manner, dummy sink current can be added to the output of the switching regulator of the power module using a programmable electrical load.

Additionally, in one embodiment, the control signals are used to instruct a switching device to pull the dummy sink current from the output of the switching regulator of the power module to reduce the amount of the current change ratio.

In this manner, dummy sink current can be added to the output of the switching regulator of the power module using a switching device.

Other forms of the embodiments of the computer-implemented method described above are in a system and in a computer program product.

As stated above, power supply systems may include a power module which provides the physical containment for several power components, such as switching regulators (e.g., DCDC switching regulators) and low-dropout (LDO) regulators. A switching regulator, such as a DCDC switching regulator, converts input direct current (DC) voltage to the desired direct current (DC) voltage. A LDO regulator is a DC linear voltage regulator that regulates the output voltage even when the input voltage is very close to the output voltage.

Multiple regulators, such as switching regulators and LDO regulators, may be placed close to the processor chips or modules in order to meet the processor's requirement (e.g., low noise margin, high rush current, etc.) for point of load (POL). Point of load (POL) power supplies solve the challenge of high peak current demands and low noise margins required by high-performance semiconductors, such as microcontrollers or ASICs, by placing individual power supply regulators (linear or DCDC) close to their point of use.

In order to implement a large current power supply system to supply power to a high-power multi-voltage system, the power module of the power supply system needs to utilize multiple regulators, such as the regulators discussed above, in order to implement POL for power distribution, save space for multiple power supplies and enable system portability.

In certain situations, the power module of the power supply system needs to handle a surge of current (referred to herein as the “rush current”) due to a sudden increase in operation load, such as a sudden increase in the load exhibited by the high-power multi-voltage system.

Such a surge of current may not be able to be handled by only the power module. For example, the de-coupling capacitor (capacitor used to decouple one part of a circuit from another) may not be able to maintain the correct voltage level to power the load. Furthermore, rush current may cause a malfunction in the power module, such as with the switching regulators (e.g., DCDC switching regulators) due to the saturation of the inductors or the destruction of the power switches. Furthermore, the malfunction of the switching regulators (e.g., DCDC switching regulators) may then cause operation problems for the LDO regulators due to having their input voltage and current supplied by such switching regulators.

Unfortunately, there is not currently a means for effectively handling such surges of current (rush currents) by the power module due to a sudden increase in operation load.

The embodiments of the present disclosure provide a means for handling rush current by predicting the rush current case and then adding a dummy load code into the program memory of the high-power multi-voltage system or adding a dummy sink current to an output of a switching regulator (e.g., DCDC switching regulator) of the power module in order to reduce the amount of the current change ratio. A further description of these and other features will be provided below.

In some embodiments of the present disclosure, the present disclosure comprises a computer-implemented method, system, and computer program product for handling a surge of current by a power supply controller, a high-power multi-voltage system, and a power module due to a sudden increase in operation load. In one embodiment of the present disclosure, a task is scheduled to be executed, where the task only includes a real load. Before executing the task, it is determined if the amount of the real load may cause the amount of the current change ratio in a power module to exceed a threshold value, which may be predicted within a certain length of the task process. A current change ratio, as used herein, refers to the ratio of the current before and after a predicted rush current. If the amount of the real load alone is predicted to cause the amount of the current change ratio to exceed the threshold value (rush current case), then the predicted rush current (surge of current) is handled by the power supply controller, the high-power multi-voltage system, and the power supply module (or the power supply system). In response to predicting a potential surge of current (rush current), a dummy load code is added into the program memory in the high-power multi-voltage system or a dummy sink current is added to an output of the switching regulator of the power module in order to avoid the rush current (surge of current case). By adding a dummy load or a dummy sink current, the current of the switching regulator is increased gradually and smoothly so as to avoid the rush current (surge of current) case. In this manner, the rush current may now be handled by the power controller, high-power multi-voltage system, and power module by reducing the amount of the current change ratio prior to the sudden increase in the operation load.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

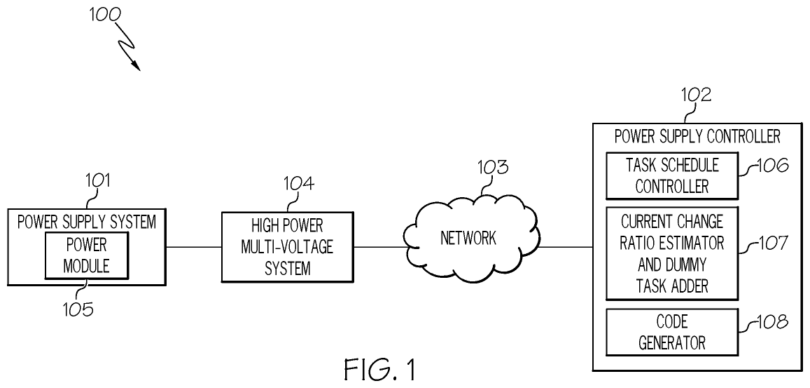

Referring now to the Figures in detail, FIG. 1 illustrates an embodiment of the present disclosure of a communication system 100 for practicing the principles of the present disclosure. Communication system 100 includes a power supply system 101, a power supply controller 102, a network 103 and a high-power multi-voltage system 104. As illustrated in FIG. 1, power supply system 101 is connected to high-power multi-voltage system 104, which is connected to power supply controller 102 via network 103. As discussed herein, power supply controller 102 is configured to predict and control the load current of a power module 105 in power supply system 101 to handle a surge of current (rush current) due to a sudden increase in the operation load.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, power supply system 101 supplies electric power to the high-power multi-voltage system 104. In one embodiment, power supply system 101 receives a single power supply voltage from an external power supply and converts it into multiple power supply voltages which are supplied to the target system, such as high-power multi-voltage system 104. For example, power supply system 101 may supply power to high-power multi-voltage system 104 that includes components, such as analog circuits, digital circuits, or custom circuits, such as memory circuits, etc.

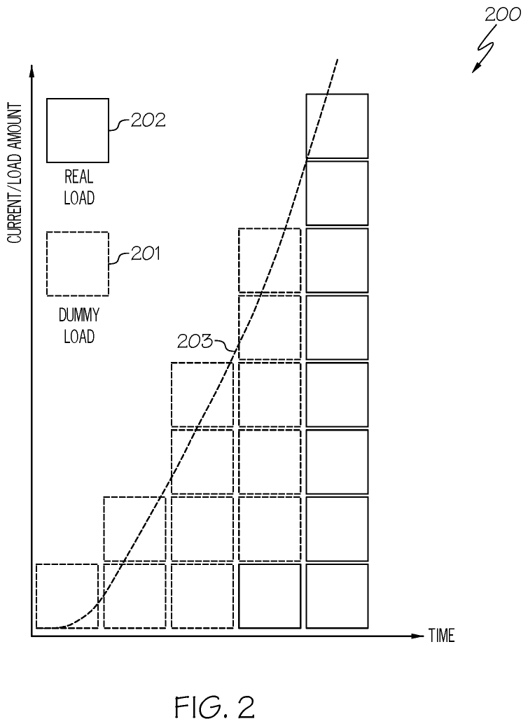

In one embodiment, power supply system 101 includes a power module 105 which provides the physical containment for several power components, such as switching regulators (e.g., DCDC switching regulators) and low-dropout (LDO) regulators as discussed further below in connection with FIGS. 2-8. A switching regulator, such as a DCDC switching regulator, converts an input direct current (DC) voltage to the desired direct current (DC) voltage. A LDO regulator is a DC linear voltage regulator that regulates the output voltage even when the supply voltage is very close to the output voltage.

As discussed above, in certain situations, power module 105 of power supply system 101 needs to handle a surge of current (referred to herein as the “rush current”) due to a sudden increase in the operation load; that is, a sudden increase in the load exhibited by high power multi-voltage system 104.

In one embodiment, such a surge of current (“rush current”) is predicted and a dummy load or a dummy sink current is scheduled by power supply controller 102. In one embodiment, dummy load code is added into memory of high-power multi-voltage system 104. In one embodiment, the dummy sink current is added to an output of a switching regulator (e.g., DCDC switching regulator) in power module 105.

In one embodiment, power supply controller 102 includes a task schedule controller 106 configured to schedule a task for execution. Furthermore, power supply controller 102 includes a current change ratio estimator and dummy task adder 107 configured to estimate the amount of the current change ratio. A current change ratio, as used herein, refers to the ratio of the current before and after a predicted rush current. If the estimated amount of the current change ratio exceeds a threshold value, which may be user-designated, then current change ratio estimator and dummy task adder 107 generates a dummy load, in addition to the real load, which is sent to code generator 108.

In one embodiment, if the amount of the current change ratio is larger than the threshold value, then the dummy load task is added to the real task. Both the real load task and the dummy load task are then converted into execution code in code generator 108. The converted code is then sent to high-power multi-voltage system 104. In one embodiment, the additional dummy load code is executed in high-power multi-voltage system 104. In one embodiment, the additional current for a dummy load code is added to an output of a switching regulator (e.g., DCDC switching regulator) in power module 105. In one embodiment, the scheduling of such tasks is dependent upon predicting the occurrence of a rush current which occurs due to a sudden increase in the operation load.

Furthermore, in one embodiment, task schedule controller 106 is configured to schedule tasks (unit of execution or work) to be executed by high-power multi-voltage system 104. In one embodiment, receiving the scheduled task from task schedule controller 106, the current change ratio estimator and dummy task adder 107 predicts the occurrence of a rush current which may occur due to a sudden increase in the operation load. That is, if the generated code (without the additional dummy code) for the sudden increase of the operation load is executed in high-power multi-voltage system 104, then the current change ratio of power module 105 will exceed the threshold value, which will indicate the rush current case.

In one embodiment, such tasks are programmed with software code, and as a result, the amount of processing to accomplish the task may be estimated. In one embodiment, task schedule controller 106 schedules a task to be executed (prior to being executed by high voltage multi-voltage system 104) that only includes a real (load) task (without the insertion of a dummy (load) task). “Real (load) task” (also referred to herein as a “real operation (load) task”), as used herein, refers to the operations that need to be performed, such as in connection with a scheduled task. A task, as used herein, refers to a unit of execution or a unit of work. Such tasks include operations to be performed, such as inputting, storing, outputting, processing, etc. Such operations that need to be performed in connection with such a task correspond to the real load. A “dummy (load) task,” as used herein, refers to operations that consume a certain amount of power at execution in high-power multi-voltage system 104 and pull corresponding current from power supply system 101 (or power module 105). The “dummy (load) task” is not required to be executed for system operation but is needed to be executed in order for power module 105 to avoid a surge of current (rush current) due to a sudden increase in the operation load. That is, dummy load code is executed to reduce the amount of the current change ratio.

Upon estimating the task that only includes a real load by the current change ratio estimator and dummy task adder 107, current change ratio estimator and dummy task adder 107 determines if the amount of the current change ratio while processing that task causes or does not cause a rush current case. Specifically, in one embodiment, the current change ratio estimator and dummy task adder 107 estimates the amount of the current change ratio for the real load to be processed within a certain period of time, which may be user-designated. If such an amount of the current change ratio exceeds a threshold value, which may be user-designated, then a rush current (surge of current) case is predicted. In one embodiment, the rush current case is avoided by current change ratio estimator and dummy task adder 107 adding the dummy task. In one embodiment, the threshold value for the current change ratio corresponds to the rush current limit of the switching regulator (e.g., DCDC switching regulator).

In response to predicting a potential surge of current (rush current), the current change ratio estimator and dummy task adder 107 adds a dummy (load) task into the real (load) task. That is, current change ratio estimator and dummy task adder 107 adds the dummy (load) task if the rush current is predicted and does not add the dummy (load) task if the rush current is not predicted. The task with or without the dummy (load) task is converted into execution code in code generator 108. In one embodiment, the dummy (load) task is converted into dummy load code and the real (load) task is converted into real load code by code generator 108.

In one embodiment, the converted execution code by code generator 108 is stored in program memory 306 (discussed below) of high-power multi-voltage system 104. When a dummy load is executed, current for dummy load code execution is pulled from power module 105 in addition to the current for real load code execution to reduce the amount of the current change ratio. Such a scheme reduces the amount of the current change ratio as discussed further below. By adding a dummy load, the total current supplied from power module 105 increases gradually and smoothly so as to minimize the amount of the current change ratio. In this manner, the rush current may now be handled by power supply controller 102, high-power multi-voltage system 104, and power module 105 by reducing the amount of the current change ratio prior to the sudden increase in the operation load.

A further discussion regarding adding a dummy load to high-power multi-voltage system 104 to reduce the amount of the current change ratio before the sudden increase in the operation load is provided below in connection with FIGS. 2-4.

Furthermore, in an alternative embodiment, in response to dummy sink current schedular 601 (discussed further below) predicting a potential surge of current (rush current) to be handled by power supply controller 102, high-power multi-voltage system 104 and power module 105, dummy sink current schedular 601 of power supply controller 102 schedules to add a dummy sink current to an output of a switching regulator (e.g., DCDC switching regulator) in power module 105 in order to reduce the amount of rush current before the sudden increase in the operation load. A “dummy sink current,” as used herein, refers to the current that flows from the output of the switching regulator to ground through a certain external load. In one embodiment, the dummy sink current is implemented using a programmable electrical load or a current controlled-switch, such as a field-effect transistor.

As discussed above, in one embodiment, task schedule controller 106 schedules the real (load) task. In one embodiment, dummy sink current schedular 601 (discussed further below) estimates the amount of the current change ratio in that task and predicts the rush current case when the estimated amount of the current change ratio exceeds a threshold value, which may be user-designated. After dummy sink current schedular 601 predicts the rush current case, dummy sink current scheduler 601 schedules the timing and the amount of the dummy sink current which is applied to an output of a switching regulator (e.g. DCDC switching regulator) of power module 105. The information of the scheduled dummy sink current is sent as control signals to power module 105 through dummy sink current controller 602 (discussed further below) of high-power multi-voltage system 104.

The scheduled dummy sink current increases the load current but reduces the amount of the current change ratio before the sudden increase in the operation load. Such an embodiment may occur when the execution of the operation load causes the amount of the current change ratio to exceed the threshold value, which may be user-designated, within a period of time, which may be user-designated. In one embodiment, the threshold value corresponds to the rush current limit of the switching regulator (e.g., DCDC switching regulator).

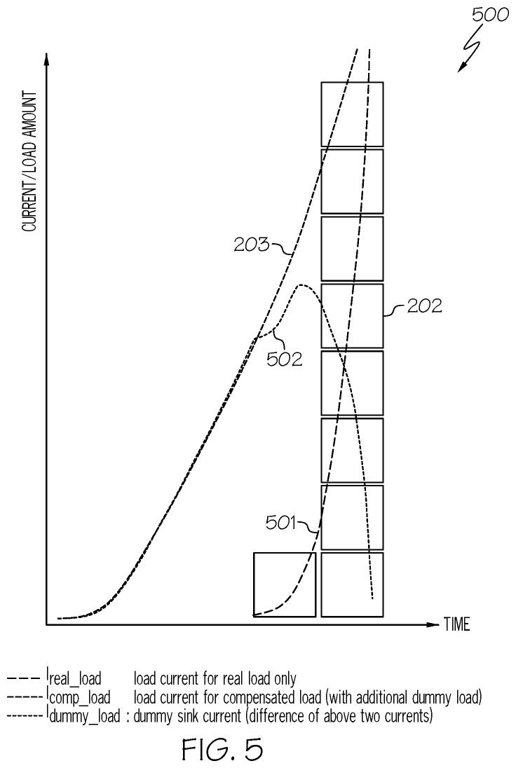

A further discussion regarding adding a dummy sink current to power module 105 to reduce the amount of the current change ratio before the sudden increase in the operation load is provided below in connection with FIGS. 5-8.

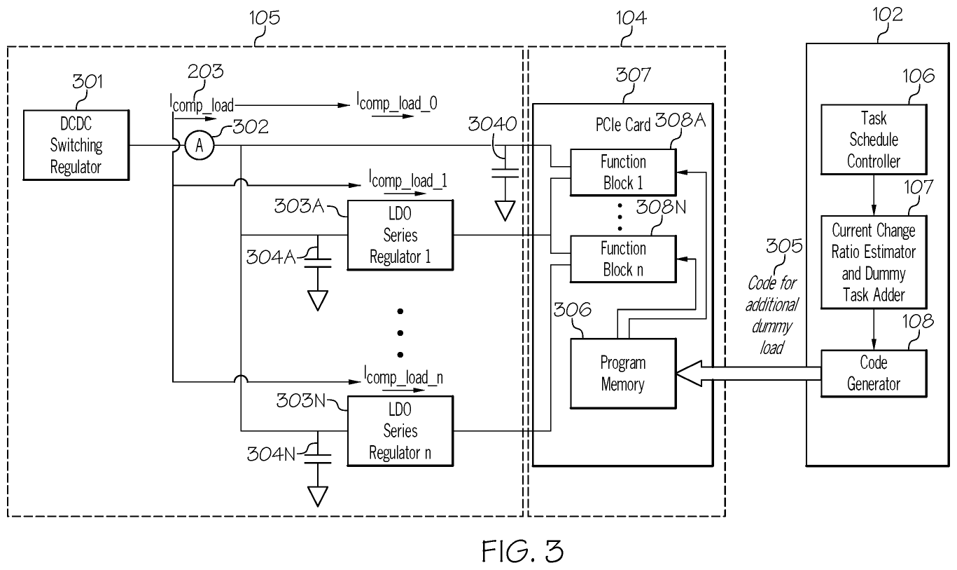

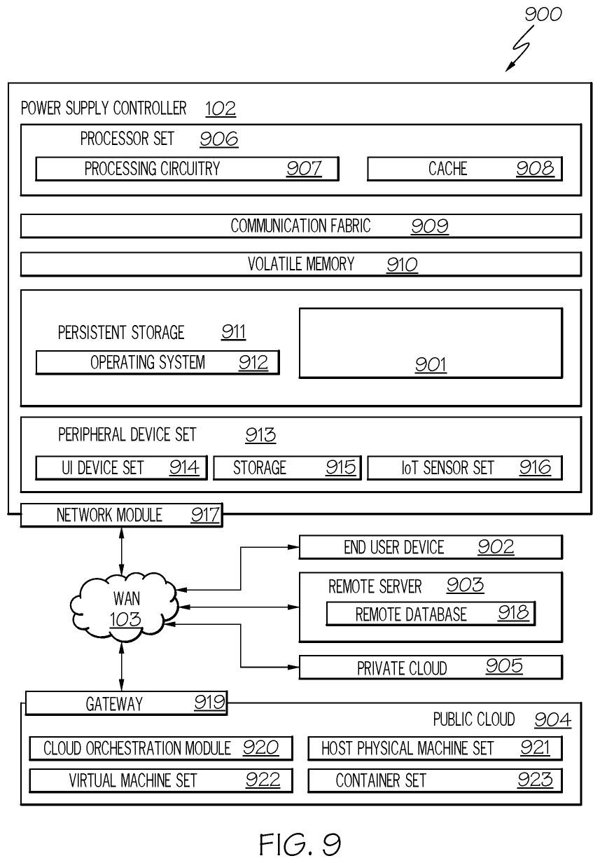

A more detailed description of these and other features will be provided further below. Furthermore, a description of the software components of power supply controller 102 is provided below in connection with FIGS. 3 and 6-7 and a description of the hardware configuration of power supply controller 102 is provided further below in connection with FIG. 9.

System 100 is not to be limited in scope to any one particular network architecture. System 100 may include any number of power supply systems 101, power supply controllers 102, networks 103, and high-power multi-voltage systems 104.

Referring now to FIG. 2, in conjunction with FIG. 1, FIG. 2 illustrates reducing the amount of the current change ratio based on prediction by placing an additional dummy load into the high-power multi-voltage system before processing the real operation load in accordance with an embodiment of the present disclosure.

As shown in FIG. 2, FIG. 2 is a graph 200 of the current/load amount (along the Y-axis) versus time (along the X-axis) in which the added dummy load 201 reduces the amount of the current change ratio before the sudden increase in the operation load which occurs at the time of processing the real operation load 202 due to having the load current 203 (I_{comp_load}) for the compensated load (with the additional dummy load) increase in a steady manner so as to reduce the amount of the current change ratio before processing real operation load 202 as shown in FIG. 2.

An example of implementing such a scheme is shown in FIG. 3. FIG. 3 illustrates a structure to achieve the amount of current change ratio reduction based on prediction by adding a dummy load into high-power multi-voltage system 104 before the sudden increase in the operation load in accordance with an embedment of the present disclosure.

Referring to FIG. 3, in conjunction with FIG. 2, power module 105 includes a switching regulator 301, such as a DCDC switching regulator. In one embodiment, switching regulator 301 converts the input direct current (DC) voltage to the desired direct current (DC) voltage. In one embodiment, the amount of the compensated load current 203 (I_{comp_load}) is monitored by current monitor 302. Current monitor 302, as used herein, refers to a current sensor that detects electric current and generates a signal proportional to that current. Examples of current monitor 302 can include, but are not limited to, the CDD series current monitor from Diversified Electronics, the CDO series current monitor from Diversified Electronics, the CDU series current monitor from Diversified Electronics, an ammeter, etc. to check the amount of the current.

In one embedment, power module 105 further includes low-dropout (LDO) series regulators 303A-303N (identified as “LDO Series Regulator 1,” . . . “LDO Series Regulator N,” respectively, in FIG. 3), where N is a positive integer number. LDO series regulators 303A-303N may collectively or individually be referred to as LDO series regulators 303 or LDO series regulator 303, respectively. LDO series regulator 303 is a DC linear voltage regulator that regulates the output voltage even when the supply voltage is very close to the output voltage.

Additionally, power module 105 includes various capacitors 304A-304N and 3040 connected to ground, where Nis a positive integer number. Capacitors 304A-304N and 3040 may collectively or individually be referred to as capacitors 304 or capacitor 304, respectively. In one embodiment, capacitors 304 are designed to filter out noise, suppress rapid voltage changes, improve feedback loop characteristics, etc. That is, capacitors 304 supply stored electric charge as current to LDO series regulators 303 to handle the sudden current requirement. In one embodiment, the number of capacitors 304 is one or more greater than the number of LDO series regulators 303.

In one embodiment, task schedule controller 106 schedules a task to be executed by high-power multi-voltage system 104 that only includes a task for real load 202 (without the insertion of a task for dummy load 201). Specifically, in one embodiment, task schedule controller 106 determines the amount of the task for real load 202 to be processed within a period of time, which may be user-designated. In one embodiment, current change ratio estimator and dummy task adder 107 estimates the amount of the current change ratio for the task initially scheduled by task schedule controller 106 with only the task for real load 202. If the estimated amount of the current change ratio exceeds the threshold value, then current change ratio estimator and dummy task adder 107 adds a dummy (load) task to the original real (load) task.

If the estimated current change ratio for processing the task for real load 202 is predicted to exceed a threshold value, which may be user-designated, within a period of time, then a predicted rush current (surge of current) to be handled by power supply controller 102, high-power multi-voltage system 104, and power module 105 may be said to occur. In one embodiment, the threshold value corresponds to the limit of the amount of current change ratio for switching regulator 301 (e.g., DCDC switching regulator).

In response to the current change ratio estimator and dummy task adder 107 predicting a potential surge of current (rush current) to be handled by power supply controller 102, high-power multi-voltage system 104, and power module 105, code generator 108 generates code 305 which corresponds to a dummy load 201, where such code 305 is sent to high-power multi-voltage system 104 and stored in program memory 306 of a PCIe (peripheral component interconnect express) card 307 (e.g., Oracle® Flash Accelerator F640 PCIe card). In one embodiment, such generated code 305 includes both the real and the dummy load. In one embodiment, such generation of code 305 occurs before program execution for the scheduled task. Even if no potential surge of current (rush current) case is predicted, code generator 108 generates code 305 which is sent to high-power multi-voltage system 104 and stored in program memory 306 of PCI card 307. However, in this case, the generated code includes code only for real load 202. In one embodiment, PCIe card 307 interfaces with power supply controller 102 directly over Gen3 PCIe and provides a high-bandwidth, low-latency, flash-based caching tier for various enterprise workloads. In one embodiment, PCIe card 307 integrates a high-performance Non-Volatile Memory Express (NVMe) controller interface. In one embodiment, PCIe card 307 is a block storage device with block sizing optimization capabilities.

In one embodiment, current change ratio estimator and dummy task adder 107 determines the amount of dummy load 201 to be added based on the extent that the current change ratio exceeds a threshold value. For example, the greater that the amount that the current change ratio exceeds the threshold value, the greater the amount of dummy load 201 is to be added in program memory 306. The timing to add dummy load (code) 201 into program memory 306 is also scheduled so that the amount of the total load change ratio, which corresponds to the amount that the total load current change ratio exceeds the threshold value, is reduced to less than threshold value. In one embodiment, such an amount of dummy load 201 to be added to the operation load of function block 1 308A to function block n 308N is determined based on a correlation of the amount of dummy load 201 to be added to the operation load of function block 1 308A to function block n 308N with the amount of dummy load current pulled from power module 105 when the dummy load is executed in function block 1 308A to function block n 308N. In one embodiment, such a determination occurs when it is predicted that the load current change ratio with real load 202 exceeds a threshold value, which may be user-designated. Such a correlation may be mathematically represented in a curve as established by an expert. In one embodiment, such a correlation is stored in a storage device of power supply controller 102. If current change ratio estimator and dummy task adder 107 predicts the real (load) task does not cause the amount of the current change ratio to exceed the threshold value, then only the real (load) task is coded by code generator 108 and the code is sent to program memory 306 of high-power multi-voltage system 104. In such a scenario, no dummy (load) task is added by current change ratio estimator and dummy task adder 107 and no dummy code is generated by code generator 108.

After storing the generated code in program memory 306 by high-power multi-voltage system 104, the program code in program memory 306 is executed by high-power multi-voltage system 104 on function blocks 1-n 308A-308N (identified as “Function Block 1,” . . . “Function Block n,” respectively, in FIG. 3), where n is a positive integer number, so that the compensated (or non-compensated) current (see element 203), which includes current for both the real load and the dummy load, is pulled when these loads are executed in function blocks 1-n 308A-N in high-power multi-voltage system 104 from the output of switching regulator 301 of power module 105 as illustrated in FIG. 3. For example, compensated load current 203 (I_{comp_load}) is pulled from the output of switching regulator 301 of power module 105 consisting of the components of I_{comp_load_0} . . . and I_{comp_load_n}, where n is a positive integer number, as shown in FIG. 3. If there is no dummy task, I_{comp_load_0} . . . and I_{comp_load_n}, include the current only for the real (load) task.

Furthermore, FIG. 3 illustrates the compensated load current 203 (I_{comp_load}) being read by current monitor 302.

In one embodiment, the components, such as switching regulator 301, current monitor 302, LDO series regulators 303, capacitors 304, and PCIe card 307 are interconnected in the manner as shown in FIG. 3. For example, capacitors 304B-304N are connected at the input of LDO series regulators 303A-303N, respectively. Furthermore, as shown in FIG. 3, capacitor 3040, LDO series regulators 303A-303N are directly connected to PCIe card 307. Additionally, as shown in FIG. 3, current monitor 302 is connected in series at the output of switching regulator 301. Furthermore, as shown in FIG. 3, current monitor 302 monitors the total current of I_{comp_load_0} . . . and I_{comp_load_n} where n is a positive integer number. Additionally, as shown in FIG. 3, current monitor 302 is connected between the output node of DCDC switching regulator 301 and the input node of LDO series regulators 303A-303N.

Power module 105 is not to be limited in scope to any one particular architecture. Power module 105 may include any number of switching regulators 301, current monitors 302, LDO series regulators 303, and capacitors 304.

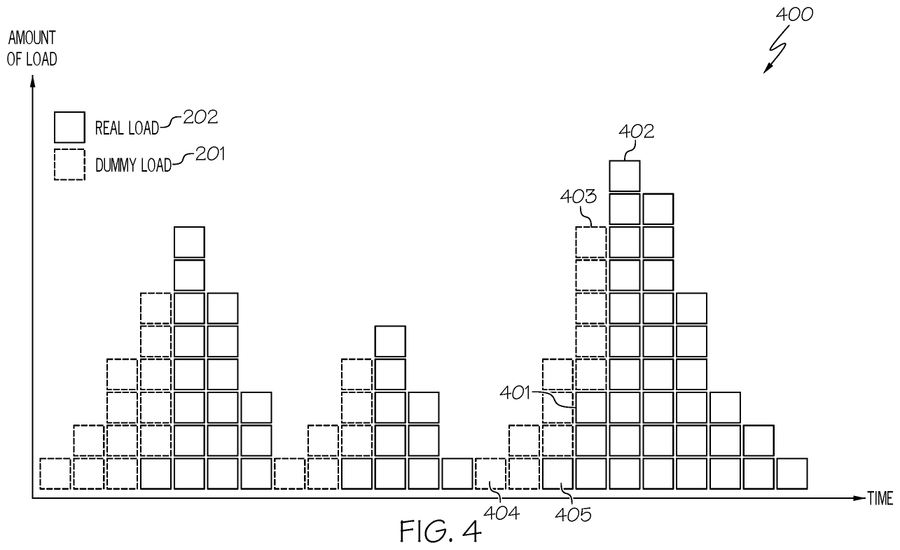

As discussed above, upon adding dummy load 201, the amount of the current change ratio is reduced before the sudden increase in the operation load. An illustration of reducing the amount of the current change ratio with a dummy load assignment is shown in FIG. 4.

FIG. 4 illustrates the total loads for the amount of the current change ratio reduction for a certain period based on prediction by utilizing a dummy load assignment in accordance with an embodiment of the present disclosure.

As shown in FIG. 4, FIG. 4 is a graph 400 of the load amount (along the Y-axis) versus time (along the X-axis) in which the added dummy load 201 to the real load 202 reduces the amount of the current change ratio before the sudden increase in the operation load. As illustrated in FIG. 4, by adding dummy load 201 to the real load 202, the total amount of operation load is smoothed out without excessive increases or decreases in the total amount of operation load. By smoothing out the total amount of operation load, the amount of the current change ratio is reduced since the amount of the sudden increase in operation load is reduced due to the added dummy load 201. For example, as shown in FIG. 4, the difference in the amount of the operation load (real load 202) between positions 401 and 402 prior to adding dummy load 201 (see position 403) would have been significant and sudden thereby causing a sudden increase in amount of the current change ratio of the load current. However, by adding dummy load 201 during the period from 404 to 401, prior to the increase in real load 202 during period from 405 to 402, the load change ratio is dramatically reduced in comparison to the scenario without adding dummy load 201 thereby reducing the amount of the current change ratio as well.

Referring now to FIG. 5, in conjunction with FIG. 1, FIG. 5 illustrates reducing the amount of the current change ratio based on prediction by adding dummy sink current to power module 105 before processing the real operation load in accordance with an embodiment of the present disclosure.

As shown in FIG. 5, FIG. 5 is a graph 500 of the current or load amount (along the Y-axis) versus time (along the X-axis) in which the added dummy sink current reduces the amount of the current change ratio before the sudden increase in the operation load.

The dummy sink current (I_{dummy_sink}) 502 is applied (or added) to the load current for real load only (I_{real_load}) 501 so that the total load current, that is, the load current for compensated load (I_{comp_load}) 203, provides a smaller amount of current change ratio than what I_{realload} 501 provides before real load 202 is executed suddenly as shown in FIG. 5. For example, as shown in FIG. 5, load current 501 (I_{real_load}) for real load 202 rises with a significantly high current change ratio. However, by utilizing dummy sink current 502 (I_{dummy_sink}), load current 203 (I_{comp_load}) for the compensated load (with the additional dummy sink current) rises in a more smooth manner effectively reducing the amount of the current change ratio before processing real operation load 202.

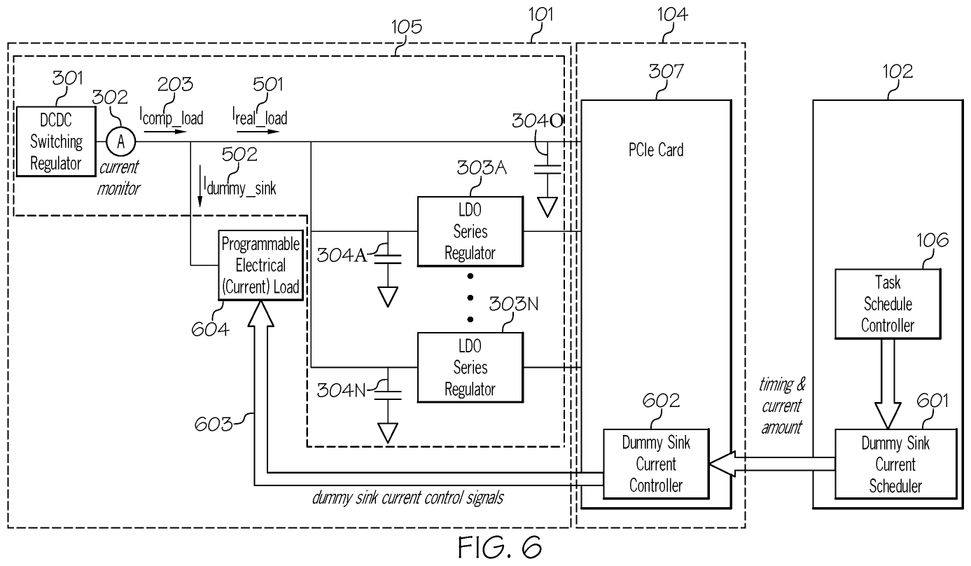

An example of implementing such a scheme using a programmable electrical load to implement the dummy sink current is shown in FIG. 6.

FIG. 6 illustrates adding the dummy sink current to the output of the switching regulator (switching regulator 301) based on prediction by using a programmable electrical load in order to reduce the amount of the current change ratio before the sudden increase in the operation load in accordance with an embodiment of the present disclosure.

Referring to FIG. 6, in conjunction with FIG. 5, power module 105 of FIG. 6 is similar to the structure of power module 105 of FIG. 3 with the exceptions discussed below.

In one embodiment, in response to dummy sink current schedular 601 predicting a potential surge of current (rush current) to be handled by power supply controller 102, high-power multi-voltage system 104, and power module 105 as discussed above, dummy sink current schedular 601 generates the predicted results. In one embodiment, the results include the amount of the current change ratio which exceeds the threshold value to identify the rush current case and the timing when the rush current case is supposed to occur by checking the task before execution. With such predicted results, the timing and current data for the dummy sink current are generated and sent to dummy sink current controller 602 of high-power multi-voltage system 104. Thus, dummy sink current schedular 601 generates data, which includes the amount of dummy sink current and the appropriate timing to add the dummy sink current. “Appropriate timing,” as used herein, refers to the time just before the occurrence of the rush current case which is predicted by dummy sink current schedular 601.

In one embodiment, dummy sink current scheduler 601 predicts the rush current case and performs steps to avoid it. In one embodiment, dummy sink current scheduler 601 estimates the amount that the current change ratio exceeds the threshold value for the rush current case and generates the timing and dummy current data.

In one embodiment, dummy sink current scheduler 601 sends timing and the current amount to dummy sink current controller 602 so that the dummy sink current controller 602 can generate control signals 603 for programmable electrical load 604 to pull (or add) the appropriate amount of dummy sink current 502 at the appropriate timing (prior to the occurrence of the rush current).

In one embodiment, upon predicting a potential surge of current (rush current) to be handled by power module 105 as discussed above, dummy sink current scheduler 601 determines the timing and amount of dummy sink current 502.

In one embodiment, dummy sink current schedular 601 determines the timing and amount of dummy sink current 502 to be added in power module 105 based on the extent that the amount of the current change ratio caused by real load 202 exceeds the threshold value for the rush current case. For the rush current case, for example, the greater that the amount that the current change radio caused by real load 202 exceeds the threshold value, the greater the amount of dummy sink current 502 is to be added in power module 105 and the quicker that such dummy sink current 502 needs to be added. In one embodiment, the amount of dummy sink current 502 to be added in power module 105 is determined based on a correlation of the amount of dummy sink current 502 to be added in power module 105 with the amount of the current change ratio caused by only real load 202 that exceeds the rush current threshold value as established by an expert. Such a correlation may be mathematically represented in a curve as established by an expert. In one embodiment, such a correlation is stored in a storage device of power supply controller 102.

In one embodiment, power supply controller 102 (dummy sink current scheduler 601) instructs a controller, referred to herein as dummy sink current controller 602, of high-power multi-voltage system 104. That instruction includes the scheduled data for appropriate timing and the appropriate amount of dummy sink current 502. In one embodiment, dummy sink current controller 602 is configured to issue control signals 603 to a programmable electrical (current) load 604 to sink current (dummy sink current 502). In one embodiment, such control signals 603 are used to instruct programmable electrical (current) load 604 as to the timing and the amount of current (dummy sink current 502) to sink. Examples of dummy sink current controller 602 can include, but are not limited to, SEA05 by ST Microelectronics®, TSM101 by ST Microelectronics®, etc.

In one embodiment, programmable electrical (current) load 604 is configured to sink current (dummy sink current 502) based on the control signals 603 received from dummy sink current controller 602. Examples of programmable electrical (current) load 604 can include, but are not limited to, 3710A from Array, SDL1030X-E from Siglant, etc.

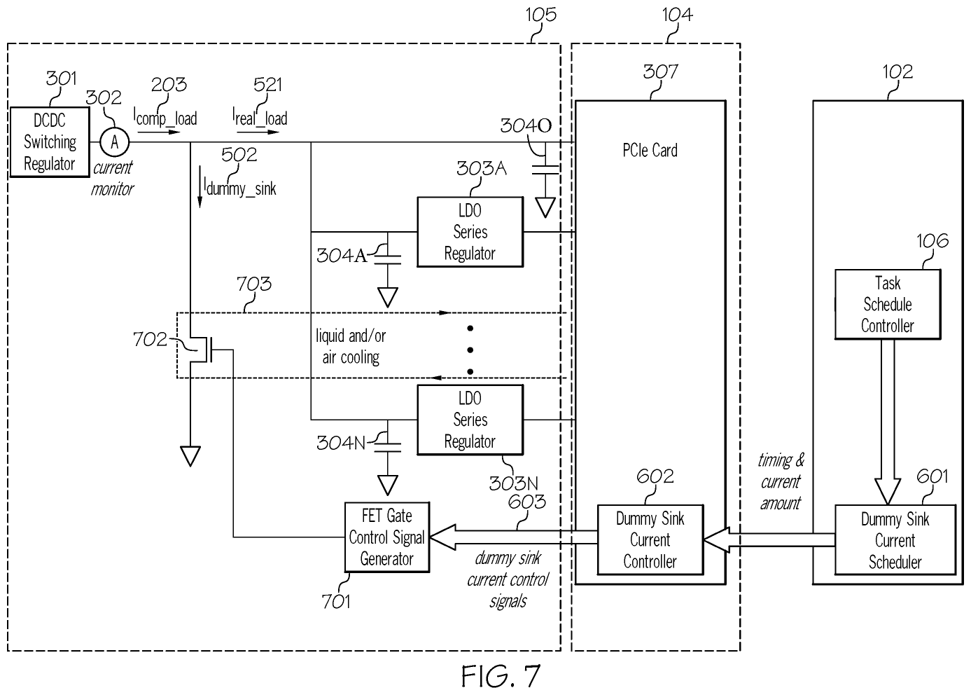

In an alternative embodiment, dummy sink current 502 is added to the output of switching regulator 301 using a current-controlled switch (e.g., field-effect transistor) as illustrated in FIG. 7.

FIG. 7 illustrates adding the dummy sink current to the output of the switching regulator (switching regulator 301) based on prediction by using a current controlled-switch in order to reduce the amount of the current change ratio before the sudden increase in the operation load in accordance with an embodiment of the present disclosure.

Referring to FIG. 7, in conjunction with FIGS. 5-6, power module 105 of FIG. 7 is similar to the structure of power module 105 of FIG. 6 with the exceptions discussed below.

In one embodiment, dummy sink current controller 602 issues control signals 603 to a control signal generator 701, such as the control signal generator for the gate of the field-effect transistor (FET) 702. The control signal controls the voltage applied to the gate of a current-controlled switch 702, such as a field-effect transistor. In one embodiment, such control signals generated by dummy sink current controller 602 are used to instruct gate control signal generator 701 to control the flow of dummy sink current 502 based on the voltage applied to the gate of current-controlled switch 702, such as a field-effect transistor. In one embodiment, such control signals are used to instruct control signal generator 701 to control the flow of dummy sink current 502 based on the voltage applied to the gate of current-controlled switch 702 in a manner that matches the timing and the amount of dummy sink current 502 to be added as predicted and requested by dummy sink current schedular 601.

In one embodiment, the timing and the amount of voltage applied to the gate of current-controlled switch 702 is based on the control signals 603 received from dummy sink current controller 602, which is the source signal of the timing and the amount of dummy sink current 502 to be added according to the prediction and the request by dummy sink current schedular 601. In one embodiment, the timing and the amount of voltage to be applied to the gate of current-controlled switch 702 by control signal generator 701 is correlated to various control signals (current control signals issued by dummy sink current controller 602) as established by an expert. In one embodiment, such a correlation is stored in a storage device of power supply controller 102.

In one embodiment, FIG. 7 further illustrates liquid and/or air cooling of a portion of power module 105 as indicated by element 703. In order to implement liquid and/or air cooling such portion 703 of power module 105, no additional heat sink is required for current-controlled switch 702 because, in most of the cases, high-power multi-voltage system 104 has heat sink equipment that is cooled down with liquid and/or air flow. Thus, the heat sink equipment for current-controlled switch 702 does not require a significant change. Only a small design change in the liquid and/or air flow path may be required.

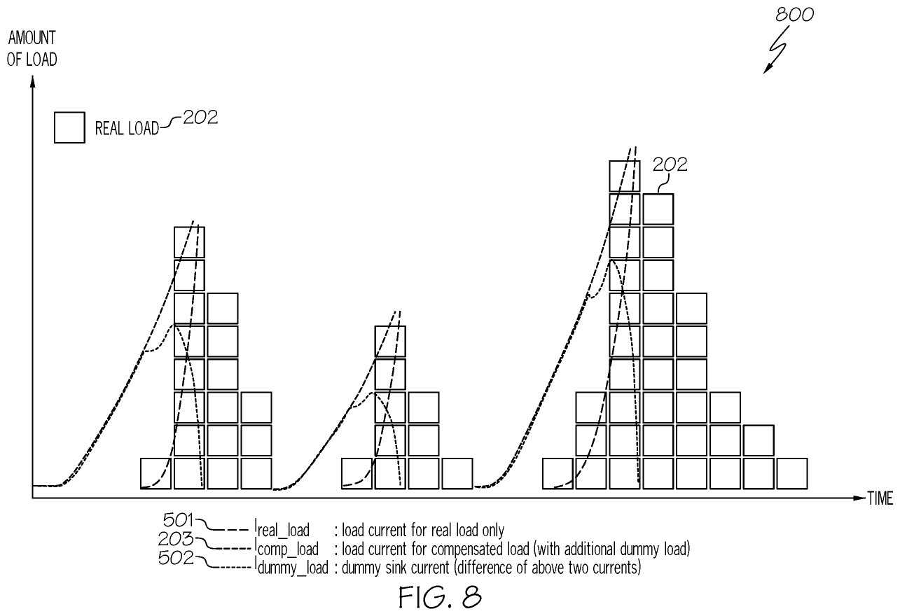

As discussed above, upon adding dummy sink current 502 in power module 105, the amount of the current change ratio is reduced to avoid the rush current case before the sudden increase in the operation load. An illustration of reducing the amount of the current change ratio with dummy sink current is shown in FIG. 8.

FIG. 8 illustrates the compensated current for the amount of the current change ratio reduction by adding the dummy sink current based on prediction in accordance with an embodiment of the present disclosure.

As shown in FIG. 8, FIG. 8 is a graph 800 of the load amount (along the Y-axis) versus time (along the X-axis) in which the added dummy sink current 502 reduces the amount of the current change ratio before the sudden increase in the operation load which occurs at the time of processing real operation load 202. The load current 203 (I_{comp_load}) compensated with the additional dummy sink current 502 (I_{dummy_sink}) increases in a steady manner so as to reduce the amount of the current change ratio before processing real operation load 202 as shown in FIG. 8. For example, as shown in FIG. 8, load current 501 (I_{real_load}) for real load 202 rises very quickly; however, by utilizing dummy sink current 502 (I_{dummy_sink}), load current 203 (I_{comp_load}) for the compensated load (with the additional dummy sink current 502 (I_{dummy_sink})) rises in a more smooth manner effectively reducing the amount of the current change ratio before processing real operation load 202.

A further description of these and other features is provided below in connection with the discussion of the method for handling a surge of current by a power module (e.g., power module 105) due to a sudden increase in the operation load.

Prior to the discussion of the method for handling a surge of current by a power module due to a sudden increase in the operation load, a description of the hardware configuration of power supply controller 102 (FIG. 1) is provided below in connection with FIG. 9.

Referring now to FIG. 9, in conjunction with FIG. 1, FIG. 9 illustrates an embodiment of the present disclosure of the hardware configuration of power supply controller 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code 901 involved in performing the inventive methods, such as handling a surge of current due to a sudden increase in the operation load. In addition to block 901, computing environment 900 includes, for example, power supply controller 102, network 103, such as a wide area network (WAN), end user device (EUD) 902, remote server 903, public cloud 904, and private cloud 905. In this embodiment, power supply controller 102 includes processor set 906 (including processing circuitry 907 and cache 908), communication fabric 909, volatile memory 910, persistent storage 911 (including operating system 912 and block 901, as identified above), peripheral device set 913 (including user interface (UI) device set 914, storage 915, and Internet of Things (IoT) sensor set 916), and network module 917. Remote server 903 includes remote database 918. Public cloud 904 includes gateway 919, cloud orchestration module 920, host physical machine set 921, virtual machine set 922, and container set 923.

Power supply controller 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 918. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically power supply controller 102, to keep the presentation as simple as possible. Power supply controller 102 may be located in a cloud, even though it is not shown in a cloud in FIG. 9. On the other hand, power supply controller 102 is not required to be in a cloud except to any extent as may be affirmatively indicated.

Processor set 906 includes one, or more, computer processors of any type now known or to be developed in the future. Processing circuitry 907 may be distributed over multiple packages, for example, multiple, coordinated integrated circuit chips. Processing circuitry 907 may implement multiple processor threads and/or multiple processor cores. Cache 908 is memory that is located in the processor chip package(s) and is typically used for data or code that should be available for rapid access by the threads or cores running on processor set 906. Cache memories are typically organized into multiple levels depending upon relative proximity to the processing circuitry. Alternatively, some, or all, of the cache for the processor set may be located “off chip.” In some computing environments, processor set 906 may be designed for working with qubits and performing quantum computing.

Computer readable program instructions are typically loaded onto power supply controller 102 to cause a series of operational steps to be performed by processor set 906 of power supply controller 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 908 and the other storage media discussed below. The program instructions, and associated data, are accessed by processor set 906 to control and direct performance of the disclosed methods. In computing environment 900, at least some of the instructions for performing the disclosed methods may be stored in block 901 in persistent storage 911.

Communication fabric 909 is the signal conduction paths that allow the various components of power supply controller 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 910 is any type of volatile memory now known or to be developed in the future. Examples include dynamic type random access memory (RAM) or static type RAM. Typically, the volatile memory is characterized by random access, but this is not required unless affirmatively indicated. In power supply controller 102, the volatile memory 910 is located in a single package and is internal to power supply controller 102, but, alternatively or additionally, the volatile memory may be distributed over multiple packages and/or located externally with respect to power supply controller 102.

Persistent Storage 911 is any form of non-volatile storage for computers that is now known or to be developed in the future. The non-volatility of this storage means that the stored data is maintained regardless of whether power is being supplied to power supply controller 102 and/or directly to persistent storage 911. Persistent storage 911 may be a read only memory (ROM), but typically at least a portion of the persistent storage allows writing of data, deletion of data and re-writing of data. Some familiar forms of persistent storage include magnetic disks and solid state storage devices. Operating system 912 may take several forms, such as various known proprietary operating systems or open source Portable Operating System Interface type operating systems that employ a kernel. The code included in block 901 typically includes at least some of the computer code involved in performing the disclosed methods.

Peripheral device set 913 includes the set of peripheral devices of power supply controller 102. Data communication connections between the peripheral devices and the other components of power supply controller 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 914 may include components such as a display screen, speaker, microphone, wearable devices (such as goggles and smart watches), keyboard, mouse, printer, touchpad, game controllers, and haptic devices. Storage 915 is external storage, such as an external hard drive, or insertable storage, such as an SD card. Storage 915 may be persistent and/or volatile. In some embodiments, storage 915 may take the form of a quantum computing storage device for storing data in the form of qubits. In embodiments where power supply controller 102 is required to have a large amount of storage (for example, where power supply controller 102 locally stores and manages a large database) then this storage may be provided by peripheral storage devices designed for storing very large amounts of data, such as a storage area network (SAN) that is shared by multiple, geographically distributed computers. IoT sensor set 916 is made up of sensors that can be used in Internet of Things applications. For example, one sensor may be a thermometer and another sensor may be a motion detector.

Network module 917 is the collection of computer software, hardware, and firmware that allows power supply controller 102 to communicate with other computers through WAN 103. Network module 917 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 917 are performed on the same physical hardware device. In other embodiments (for example, embodiments that utilize software-defined networking (SDN)), the control functions and the forwarding functions of network module 917 are performed on physically separate devices, such that the control functions manage several different network hardware devices. Computer readable program instructions for performing the disclosed methods can typically be downloaded to power supply controller 102 from an external computer or external storage device through a network adapter card or network interface included in network module 917.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 902 is any computer system that is used and controlled by an end user (for example, a customer of an enterprise that operates power supply controller 102), and may take any of the forms discussed above in connection with power supply controller 102. EUD 902 typically receives helpful and useful data from the operations of power supply controller 102. For example, in a hypothetical case where power supply controller 102 is designed to provide a recommendation to an end user, this recommendation would typically be communicated from network module 917 of power supply controller 102 through WAN 103 to EUD 902. In this way, EUD 902 can display, or otherwise present, the recommendation to an end user. In some embodiments, EUD 902 may be a client device, such as thin client, heavy client, mainframe computer, desktop computer and so on.

Remote server 903 is any computer system that serves at least some data and/or functionality to power supply controller 102. Remote server 903 may be controlled and used by the same entity that operates power supply controller 102. Remote server 903 represents the machine(s) that collect and store helpful and useful data for use by other computers, such as power supply controller 102. For example, in a hypothetical case where power supply controller 102 is designed and programmed to provide a recommendation based on historical data, then this historical data may be provided to power supply controller 102 from remote database 918 of remote server 903.

Public cloud 904 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 904 is performed by the computer hardware and/or software of cloud orchestration module 920. The computing resources provided by public cloud 904 are typically implemented by virtual computing environments that run on various computers making up the computers of host physical machine set 921, which is the universe of physical computers in and/or available to public cloud 904. The virtual computing environments (VCEs) typically take the form of virtual machines from virtual machine set 922 and/or containers from container set 923. It is understood that these VCEs may be stored as images and may be transferred among and between the various physical machine hosts, either as images or after instantiation of the VCE. Cloud orchestration module 920 manages the transfer and storage of images, deploys new instantiations of VCEs and manages active instantiations of VCE deployments. Gateway 919 is the collection of computer software, hardware, and firmware that allows public cloud 904 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 905 is similar to public cloud 904, except that the computing resources are only available for use by a single enterprise. While private cloud 905 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 904 and private cloud 905 are both part of a larger hybrid cloud.

Block 901 further includes the software components discussed above in connection with FIGS. 2-8 to handle a surge of current due to a sudden increase in the operation load. In one embodiment, such components may be implemented in hardware. The functions discussed above performed by such components are not generic computer functions. As a result, power supply controller 102 is a particular machine that is the result of implementing specific, non-generic computer functions.

In one embodiment, the functionality of such software components of power supply controller 102, including the functionality for handling a surge of current due to a sudden increase in the operation load, may be embodied in an application specific integrated circuit.

As stated above, power supply systems may include a power module which provides the physical containment for several power components, such as switching regulators (e.g., DCDC switching regulators) and low-dropout (LDO) regulators. A switching regulator, such as a DCDC switching regulator, converts input direct current (DC) voltage to the desired direct current (DC) voltage. A LDO regulator is a DC linear voltage regulator that regulates the output voltage even when the input voltage is very close to the output voltage. Multiple regulators, such as switching regulators and LDO regulators, may be placed close to the processor chips or modules in order to meet the processor's requirement (e.g., low noise margin, high rush current, etc.) for point of load (POL). Point of load (POL) power supplies solve the challenge of high peak current demands and low noise margins required by high-performance semiconductors, such as microcontrollers or ASICs, by placing individual power supply regulators (linear or DCDC) close to their point of use. In order to implement a large current power supply system to supply power to a high-power multi-voltage system, the power module of the power supply system needs to utilize multiple regulators, such as the regulators discussed above, in order to implement POL for power distribution, save space for multiple power supplies and enable system portability. In certain situations, the power module of the power supply system needs to handle a surge of current (referred to herein as the “rush current”) due to a sudden increase in operation load, such as a sudden increase in the load exhibited by the high-power multi-voltage system. Such a surge of current may not be able to be handled by only the power module. For example, the de-coupling capacitor (capacitor used to decouple one part of a circuit from another) may not be able to maintain the correct voltage level to power the load. Furthermore, rush current may cause a malfunction in the power module, such as with the switching regulators (e.g., DCDC switching regulators) due to the saturation of the inductors or the destruction of the power switches. Furthermore, the malfunction of the switching regulators (e.g., DCDC switching regulators) may then cause operation problems for the LDO regulators due to having their input voltage and current supplied by such switching regulators. Unfortunately, there is not currently a means for effectively handling such surges of current (rush currents) by the power module due to a sudden increase in operation load.

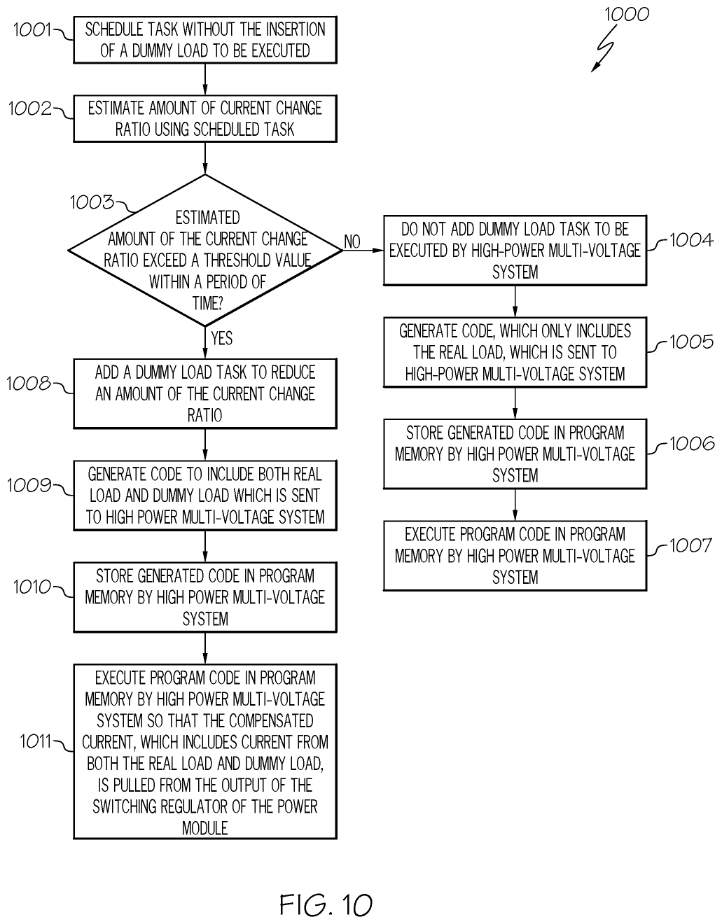

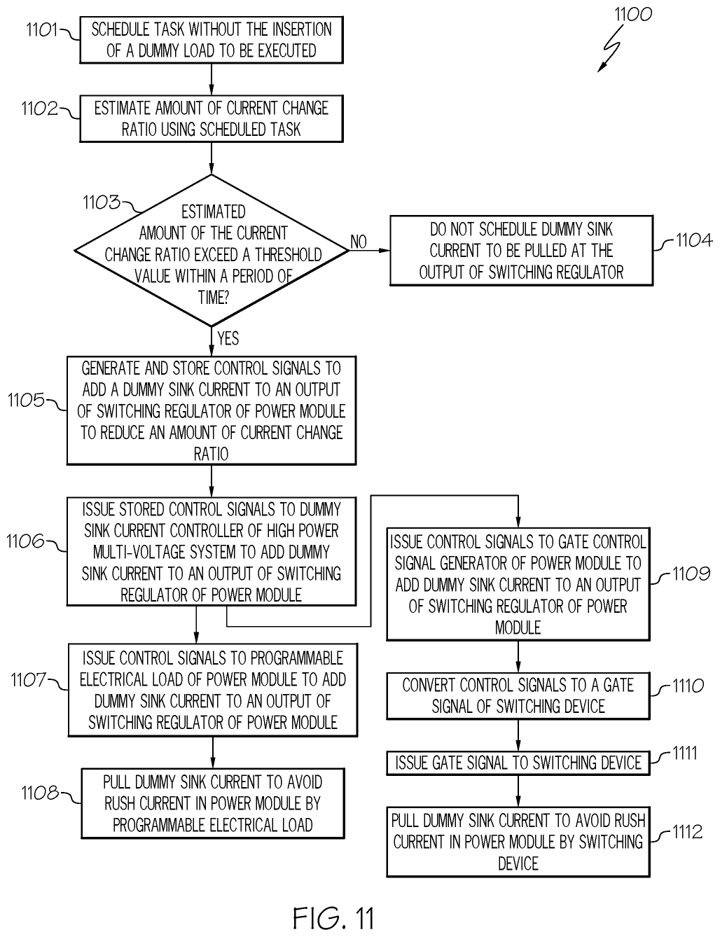

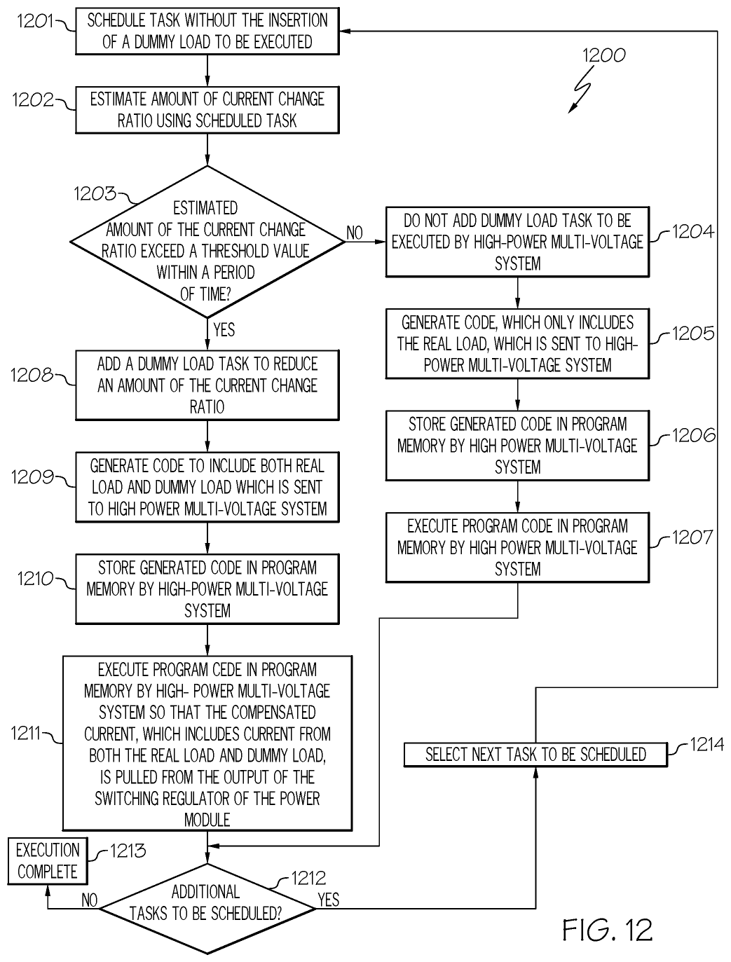

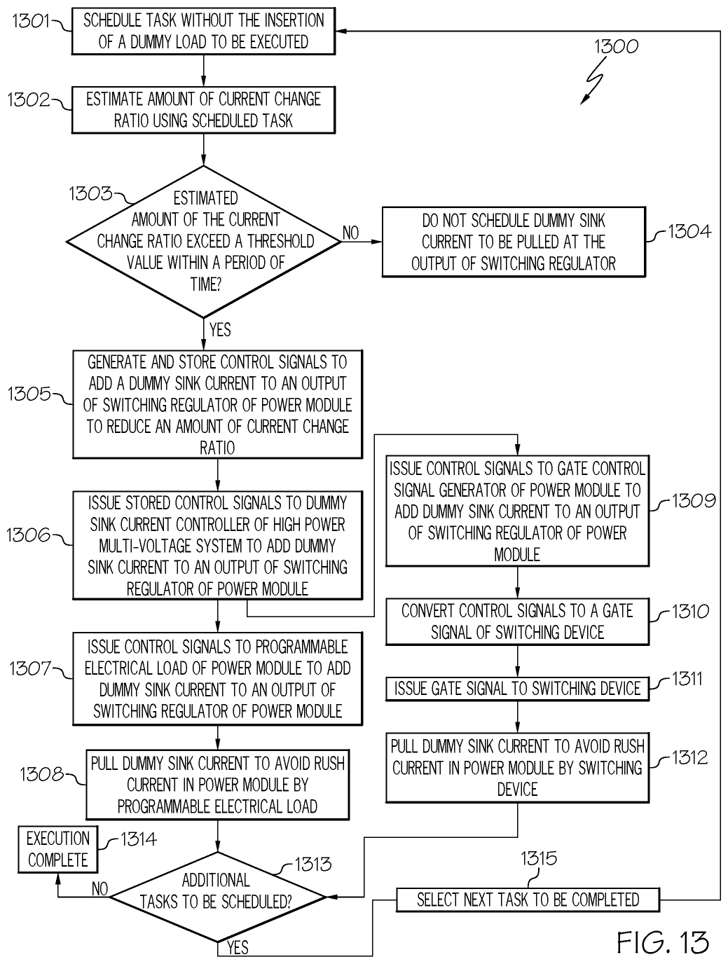

The embodiments of the present disclosure provide a means for handling rush current with the power supply controller, the high-power multi-voltage system, and the power module to predict the rush current case and to reduce the amount of the current change ratio by adding a dummy load or dummy sink current as discussed below in connection with FIGS. 10-13. FIG. 10 is a flowchart of a method for handling a surge of current by the power module, the high-power multi-voltage system, and the power supply controller due to a sudden increase in the operation load based on prediction by adding a dummy load. FIG. 11 is a flowchart of a method for handling a surge of current by the power module, the high-power multi-voltage system, and the power supply controller due to a sudden increase in the operation load based on prediction by adding a dummy sink current directly to an output of the switching regulator of the power module. FIG. 12 is a flowchart of a method of a dynamic control scheme for handling a surge of current by the power module, the high-power multi-voltage system, and the power supply controller due to a sudden increase in the operation load based on prediction by adding a dummy load. FIG. 13 is a flowchart of a method of a dynamic control scheme for handling a surge of current by the power module, the high-power multi-voltage system, and the power supply controller due to a sudden increase in the operation load based on prediction by adding a dummy sink current directly to an output of the switching regulator of the power module.

As stated above, FIG. 10 is a flowchart of a method 1000 for handling a surge of current by power module 105, high-power multi-voltage system 104, and power supply controller 102 due to a sudden increase in the operation load based on prediction by adding a dummy load in accordance with an embodiment of the present disclosure.

Referring to FIG. 10, in conjunction with FIGS. 1-4 and 9, in step 1001, task schedule controller 106 of power supply controller 102 schedules a task prior to being executed by high-power multi-voltage system 104 that only includes real load 202 (without the insertion of dummy load 201).

In step 1002, current change ratio estimator and dummy task adder 206 of power supply controller 102 estimates the amount of the current change ratio using the scheduled task (see step 1001), which only includes real load 202, in order to predict the rush current case with only real load 202.

As discussed above, in one embodiment, upon checking the scheduled task, current change ratio estimator and dummy task adder 107 predicts the portion in the task at which the amount of the current change ratio exceeds the threshold value, which may be user-designated, by estimating the amount of the current change ratio within a period of time, which may be user-designated. In one embodiment, current change ratio estimator and dummy task adder 107 predicts the amount that the current change ratio exceeds the threshold value, which may be user-designated, with only real load 202. In one embodiment, current change ratio estimator and dummy task adder 107 also adds the appropriate amount of the dummy (load) task into the original (load) task at the appropriate time if the amount of the current change ratio is predicted to exceed the threshold value, which may be user-designated.

In step 1003, current change ratio estimator and dummy task adder 107 of power supply controller 102 determines whether the estimated amount of the current change ratio caused by real load 202 exceeds a threshold value, which may be user-designated, within a certain period of time, which may be user-designated.

As stated above, if real load 202 causes the amount of the current change ratio to exceed the threshold value, which may be user-designated, within the period of time, then a predicted rush current (surge of current) to be handled by power supply controller 102, high-power multi-voltage system 104, and power module 105 may be said to occur. In one embodiment, the threshold value corresponds to the limit of the amount of the current change ratio for switching regulator 301 (e.g., DCDC switching regulator).

If the amount of real load 202 does not cause the amount of the current change ratio to exceed the threshold value within the period of time, then, in step 1004, current change ratio estimator and dummy task adder 107 of power supply controller 102 does not add a dummy (load) task to be executed by high-power multi-voltage system 104 (prior to being executed by high-power multi-voltage system 104).

In step 1005, code generator 108 of power supply controller 102 generates code 305, which only includes real load 202, which is sent to high-power multi-voltage system 104. In one embodiment, such generation of code 305 occurs before program execution or during program execution.

In step 1006, high-power multi-voltage system 104 stores code 305 in program memory 306 of PCIe (peripheral component interconnect express) card 307 (e.g., Oracle® Flash Accelerator F640 PCIe card).

In step 1007, high-power multi-voltage system 104 executes the program code stored in program memory 306.

If, however, the amount of the current change ratio caused by real load 202 does exceed the threshold value within the period of time, then, in step 1008, current change ratio estimator and dummy task adder 107 of power supply controller 102 adds a dummy (load) task to reduce the amount of the current change ratio. A “dummy load,” as used herein, refers to operations that are not required to be performed by the task but are needed to be performed in order for power module 105 to avoid a surge of current (rush current) due to a sudden increase in the operation load.

In one embodiment, current change ratio estimator and dummy task adder 107 determines the amount of dummy load 201 to be added based on the extent that the amount of the current change ratio caused by real load 202 exceeds the threshold value. For example, the greater that the amount of the current change ratio caused by real load 202 exceeds the threshold value, the greater the amount of dummy load 201 is to be added into program memory 306 of high-power multi-voltage system 104. In one embodiment, such an amount of dummy load 201 to be added to the operation load of high-power multi-voltage system 104 is determined based on the amount that the current change ratio caused by real load 202 exceeds the threshold value as established by an expert. Such a correlation may be mathematically represented in a curve as established by an expert. In one embodiment, such a correlation is stored in a storage device (e.g., storage device 911, 915) of power supply controller 102.

In step 1009, code generator 108 of power supply controller 102 generates code 305, which includes both real load 202 and dummy load 201, which is sent to high-power multi-voltage system 104. In one embodiment, such generation of code 305 occurs before program execution or during program execution.

In step 1010, high-power multi-voltage system 104 stores code 305 in program memory 306 of PCIe (peripheral component interconnect express) card 307 (e.g., Oracle® Flash Accelerator F640 PCIe card).

After storing the generated code in program memory 306 of high-power multi-voltage system 104, in step 1011, high-power multi-voltage system 104 executes the program code stored in program memory 306 at function blocks 308 so that the compensated current (see element 203), which includes current from both real load 202 and dummy load 201, is pulled from the output of switching regulator 301 of power module 105 as illustrated in FIG. 3. For example, compensated load current 203 (I_{comp_load}) is pulled from the output of switching regulator 301 of power module 105 consisting of the components of I_{comp_load_0} . . . I_{comp_load_n}, where n is a positive integer number, as shown in FIG. 3.

An illustration of reducing the amount of the current change ratio with a dummy load assignment is shown in FIG. 4.

As illustrated in FIG. 4, by adding dummy load 201 to the real load 202, the total amount of operation load is smoothed out without excessive increases or decreases in the total amount of operation load. By smoothing out the total amount of operation load, the amount of the current change ratio is reduced since the amount of the sudden increase in operation load is reduced due to the added dummy load 201. For example, as shown in FIG. 4, the difference in the amount of the operation load (real load 202) between positions 401 and 402 prior to adding dummy load 201 (see position 403) would have been significant and sudden thereby causing a sudden increase in the amount of the current change ratio of the load current. However, by adding dummy load 201 during the period from 404 to 401, prior to the increase in real load 202 during the period from 405 to 402, the load change ratio is dramatically reduced in comparison to the scenario without adding dummy load 201 thereby reducing the amount of the current change ratio as well.

An embodiment of handling a surge of current by power supply controller 102, high-power multi-voltage system 104, and power module 105 due to a sudden increase in the operation load by adding a dummy sink current to an output of switching regulator 301 of power module 105 is now discussed below in connection with FIG. 11.

FIG. 11 is a flowchart of a method 1100 for handling a surge of current by power module 105, high-power multi-voltage system 104, and power supply controller 102 due to a sudden increase in the operation load based on prediction by adding a dummy sink current directly to an output of witching regulator 301 of power module 105 in accordance with an embodiment of the present disclosure.

Referring to FIG. 11, in conjunction with FIGS. 1 and 5-9, in step 1101, task schedule controller 106 of power supply controller 102 schedules a task prior to being executed by high-power multi-voltage system 104 that only includes real load 202 (without the insertion of dummy load 201).

In step 1102, dummy sink current scheduler 601 of power supply controller 102 estimates the amount of the current change ratio using the scheduled task (see step 1101), which only includes real load 202, in order to predict the rush current case with only real load 202.

As discussed above, in one embodiment, upon checking the scheduled task, dummy sink current scheduler 601 predicts the portion in the task at which the amount of the current change ratio exceeds the threshold value, which may be user-designated, by estimating the current change ratio. In one embodiment, dummy sink current scheduler 601 also predicts the amount of the current change ratio that exceeds to the threshold value, which may be user designated, with only real load 202.

In step 1103, dummy sink current scheduler 601 of power supply controller 102 determines whether the estimated amount of the current change ratio caused by real load 202 exceeds a threshold value, which may be user-designated, within a certain period of time, which may be user-designated.

As stated above, if such a real load 202 causes the amount of the current change ratio to exceed the threshold value, which may be user-designated, within the period of time, then a predicted rush current (surge of current) to be handled by power supply controller 102, high-power multi-voltage system 104, and power module 105 may be said to occur. In one embodiment, the threshold value corresponds to the limit of the current change ratio for the switching regulator 301 (e.g., DCDC switching regulator).

If the amount of real load 202 does not cause the amount of the current change ratio to exceed the threshold value within the period of time, then, in step 1104, dummy sink current scheduler 601 of power supply controller 102 does not schedule any dummy sink current to be pulled at the output of DCDC switching regulator 301.

If, however, the amount of the current change ratio caused by real load 202 does exceed the threshold value within the period of time, then, in step 1105, dummy sink current scheduler 601 of power supply controller 102 generates and stores control signals to add a dummy sink current to the output of switching regulator 301 of power module 105 to reduce an amount of the current change ratio.

As discussed above, in one embodiment, such control signals are stored in dummy sink current scheduler 601. In one embodiment, such generation and storage of control signals to add a dummy sink current to an output of switching regulator 301 of power module 105 to reduce an amount of the current change ratio is performed when the program execution arrives at that point.

In one embodiment, dummy sink current scheduler 601 determines the timing and the amount of dummy sink current 502 to be added in power module 105 based on the extent that the amount of the current change ratio caused by real load 202 exceeds the threshold value. For example, the greater that the amount of current change ratio caused by real load 202 exceeds the threshold value, the greater the amount of dummy sink current 502 is to be added in power module 105 and the quicker that such dummy sink current 502 needs to be added. In one embodiment, the amount of dummy sink current 502 to be added in power module 105 is determined based on a correlation of the amount of dummy sink current 502 to be added in power module 105 with the amount that the current change ratio caused by real load 202 exceeds the threshold value as established by an expert. Such a correlation may be mathematically represented in a curve as established by an expert. In one embodiment, such a correlation is stored in a storage device (e.g., storage device 911, 915) of power supply controller 102.

In step 1106, dummy sink current scheduler 601 of power supply controller 102 issues such stored control signals to a controller 602 (referred to herein as the dummy sink current controller) of high-power multi-voltage system 104 at the appropriate timing (at the occurrence of the rush current) to add dummy sink current 502 to an output of switching regulator 301 of power module 105. That is, dummy sink current scheduler 601 of power supply controller 102 issues such stored current signals to dummy sink current controller 602 of high-power multi-voltage system 104 through PCI card 307 interface with the scheduling of the timing and amount of dummy sink current 502.

In one embodiment, in step 1107, dummy sink current controller 602 of high power multi-voltage system 104 issues control signals 603 to a programmable electrical (current) load 604 to add dummy sink current to an output of switching regulator 301 of power module 105. That is, dummy sink current controller 602 issues control signals 603 to a programmable electrical (current) load 604 to sink current (dummy sink current 502). In one embodiment, such control signals 603 are used to instruct programmable electrical (current) load 604 as to the timing and the amount of current (dummy sink current 502) to sink. Examples of dummy sink current controller 602 can include, but are not limited to, integrated circuits, SEA05 by ST Microelectronics®, TSM101 by ST Microelectronics®, etc.

In step 1108, programmable electrical (current) load 604 of power module 105 pulls dummy sink current 502 to avoid the rush current. That is, programmable electrical (current) load 604 of power module 105 sinks current (dummy sink current 502) based on the control signals 603 received from dummy sink current controller 602. Examples of programmable electrical (current) load 604 can include, but are not limited to, 3710A from Array, SDL1030X-E from Siglant, etc.

As an alternative to performing steps 1107-1108, steps 1109-1112 are performed as discussed below.

In one embodiment, in step 1109, dummy sink current controller 602 of high power multi-voltage system 104 issues control signals 603 to control signal generator 701 of power module 105, such as a field-effect transistor (FET) gate control signal generator, to add dummy sink current to an output of switching regulator 301 of power module 105.

In step 1110, control signal generator 701 of power module 105 converts the control signal to a gate signal of switching device 702.

In step 1111, control signal generator 701 of power module 105 issues the gate signal to switching device 702.

As discussed above, control signal generator 701 generates the voltage applied to the gate of a current-controlled switch 702, such as a field-effect transistor. In one embodiment, such first-stage control signals generated by dummy sink current controller 602 are used to instruct control signal generator 701 to generate second-stage control signals which generate dummy sink current 502 based on the voltage applied to the gate of current-controlled switch 702, such as a field-effect transistor. In one embodiment, such first-stage control signals are used to instruct control signal generator 701 to control the flow of dummy sink current 502 based on the voltage applied to the gate of current-controlled switch 702 in a manner that matches the timing and the amount of dummy sink current 502 to be added as requested by dummy sink current scheduler 601.

In one embodiment, the timing and the amount of voltage applied to the gate of current-controlled switch 702 is based on the control signals 603 received from dummy sink current controller 602, which generates the timing and the amount of dummy sink current 502 to be added as requested by dummy sink current scheduler 601. In one embodiment, the timing and the amount of voltage to be applied to the gate of current-controlled switch 702 generated by control signal generator 701 is correlated to the dummy sink current control signals 603 (issued by dummy sink current controller 602) as established by an expert. In one embodiment, such a correlation is stored in a storage device (e.g., storage device 911, 915) of power supply controller 102. Furthermore, the stored control signals are generated by dummy sink current scheduler 601 of power supply controller 102, for example, in digital format.

In step 1112, switching device 702 (e.g., current-controlled switch) pulls the dummy sink current to avoid the rush current in power module 105.

An illustration of reducing the amount of current change ratio with dummy sink current is shown in FIG. 8.

As shown in FIG. 8, FIG. 8 is a graph 800 of the load amount (along the Y-axis) versus time (along the X-axis) in which the added dummy sink current 502 reduces the amount of the current change ratio before the sudden increase in the operation load which occurs at the time of processing the suddenly increased real operation load 202 due to having the load current 203 (I_{comp_load}) for the compensated load (with the additional dummy sink current) increase in a steady manner so as to reduce the amount of the current change ratio before processing the suddenly increased real operation load 202 as shown in FIG. 8. For example, as shown in FIG. 8, load current 501 (I_{real_load}) for real load 202 significantly rises; however, by utilizing dummy sink current 502 (I_{dummy_sink}), compensated load current 203 (I_{comp_load}) with the additional dummy sink current 502 rises in a more smooth manner effectively reducing the amount of the current change ratio before processing the suddenly increased real operation load 202.

A dynamic control scheme for handling a surge of current by power module 105, high-power multi-voltage system 104, and power supply controller 102 due to a sudden increase in the operation load based on prediction by adding a dummy load is discussed below in connection with FIG. 12.

FIG. 12 is a flowchart of a method 1200 of a dynamic control scheme for handling a surge of current by power module 105, high-power multi-voltage system 104, and power supply controller 102 due to a sudden increase in the operation load based on prediction by adding a dummy load in accordance with an embodiment of the present disclosure.

Referring to FIG. 12, in conjunction with FIGS. 1-4 and 9-10, in step 1201, task schedule controller 106 of power supply controller 102 schedules a task prior to being executed by high-power multi-voltage system 104 that only includes real load 202 (without the insertion of dummy load 201).

In step 1202, current change ratio estimator and dummy task adder 206 of power supply controller 102 estimates the amount of the current change ratio using the scheduled task (see step 1201), which only includes real load 202, in order to predict the rush current case with only real load 202.

As discussed above, in one embodiment, upon checking the scheduled task, current change ratio estimator and dummy task adder 107 predicts the portion in the task at which the amount of the current change ratio exceeds the threshold value, which may be user-designated, by estimating the amount of the current change ratio within a period of time, which may be user-designated. In one embodiment, current change ratio estimator and dummy task adder 107 predicts the amount that the current change ratio exceeds the threshold value, which may be user-designated, with only real load 202. In one embodiment, current change ratio estimator and dummy task adder 107 also adds the appropriate amount of the dummy (load) task into the original (load) task at the appropriate time if the amount of the current change ratio is predicted to exceed the threshold value, which may be user-designated.

In step 1203, current change ratio estimator and dummy task adder 107 of power supply controller 102 determines whether the estimated amount of the current change ratio caused by real load 202 exceeds a threshold value, which may be user-designated, within a certain period of time, which may be user-designated.

As stated above, if real load 202 causes the amount of the current change ratio to exceed the threshold value, which may be user-designated, within the period of time, then a predicted rush current (surge of current) to be handled by power supply controller 102, high-power multi-voltage system 104, and power module 105 may be said to occur. In one embodiment, the threshold value corresponds to the limit of the amount of the current change ratio for switching regulator 301 (e.g., DCDC switching regulator).

If the amount of real load 202 does not cause the amount of the current change ratio to exceed the threshold value within the period of time, then, in step 1204, current change ratio estimator and dummy task adder 107 of power supply controller 102 does not add a dummy (load) task to be executed by high-power multi-voltage system 104 (prior to being executed by high-power multi-voltage system 104).

In step 1205, code generator 108 of power supply controller 102 generates code 305, which only includes real load 202, which is sent to high-power multi-voltage system 104. In one embodiment, such generation of code 305 occurs before program execution or during program execution.

In step 1206, high-power multi-voltage system 104 stores code 305 in program memory 306 of PCIe (peripheral component interconnect express) card 307 (e.g., Oracle® Flash Accelerator F640 PCIe card).

In step 1207, high-power multi-voltage system 104 executes the program code stored in program memory 306.

If, however, the amount of the current change ratio caused by real load 202 does exceed the threshold value within the period of time, then, in step 1208, current change ratio estimator and dummy task adder 107 of power supply controller 102 adds a dummy (load) task to reduce the amount of the current change ratio. A “dummy load,” as used herein, refers to operations that are not required to be performed by the task but are needed to be performed in order for power module 105 to avoid a surge of current (rush current) due to a sudden increase in the operation load.

In one embodiment, current change ratio estimator and dummy task adder 107 determines the amount of dummy load 201 to be added based on the extent that the amount of the current change ratio caused by real load 202 exceeds the threshold value. For example, the greater that the amount of the current change ratio caused by real load 202 exceeds the threshold value, the greater the amount of dummy load 201 is to be added into program memory 306 of high-power multi-voltage system 104. In one embodiment, such an amount of dummy load 201 to be added to the operation load of high-power multi-voltage system 104 is determined based on the amount that the current change ratio caused by real load 202 exceeds the threshold value as established by an expert. Such a correlation may be mathematically represented in a curve as established by an expert. In one embodiment, such a correlation is stored in a storage device (e.g., storage device 911, 915) of power supply controller 102.

In step 1209, code generator 108 of power supply controller 102 generates code 305, which includes both real load 202 and dummy load 201, which is sent to high-power multi-voltage system 104. In one embodiment, such generation of code 305 occurs before program execution or during program execution.

In step 1210, high-power multi-voltage system 104 stores code 305 in program memory 306 of PCIe (peripheral component interconnect express) card 307 (e.g., Oracle® Flash Accelerator F640 PCIe card).

After storing the generated code in program memory 306 of high-power multi-voltage system 104, in step 1211, high-power multi-voltage system 104 executes the program code stored in program memory 306 at function blocks 308 so that the compensated current (see element 203), which includes current from both real load 202 and dummy load 201, is pulled from the output of switching regulator 301 of power module 105 as illustrated in FIG. 3. For example, compensated load current 203 (I_{comp_load}) is pulled from the output of switching regulator 301 of power module 105 consisting of the components of I_{comp_load_0} . . . . I_{comp_load_n}, where n is a positive integer number, as shown in FIG. 3.

An illustration of reducing the amount of the current change ratio with a dummy load assignment is shown in FIG. 4.

As illustrated in FIG. 4, by adding dummy load 201 to the real load 202, the total amount of operation load is smoothed out without excessive increases or decreases in the total amount of operation load. By smoothing out the total amount of operation load, the amount of the current change ratio is reduced since the amount of the sudden increase in operation load is reduced due to the added dummy load 201. For example, as shown in FIG. 4, the difference in the amount of the operation load (real load 202) between positions 401 and 402 prior to adding dummy load 201 (see position 403) would have been significant and sudden thereby causing a sudden increase in the amount of the current change ratio of the load current. However, by adding dummy load 201 during the period from 404 to 401, prior to the increase in real load 202 during the period from 405 to 402, the load change ratio is dramatically reduced in comparison to the scenario without adding dummy load 201 thereby reducing the amount of the current change ratio as well.

Upon executing the program code in program memory 306 in step 1207 or step 1211, in step 1212, task schedule controller 106 of power supply controller 102 determines if there are additional tasks to be scheduled.

If there are no more additional tasks to be scheduled, then, in step 1213, task schedule controller 106 of power supply controller 102 completes the execution of method 1200.

If, however, there are additional tasks to be scheduled, then, in step 1214, task schedule controller 106 of power supply controller 102 selects the next task to be scheduled. Upon selecting the next task to be scheduled, task schedule controller 106 of power supply controller 102 schedules the next selected task prior to being executed by high-power multi-voltage system 104 that only includes real load 202 (without the insertion of dummy load 201) in step 1201.

A dynamic control scheme for handling a surge of current by power module 105, high-power multi-voltage system 104, and power supply controller 102 due to a sudden increase in the operation load based on prediction by adding a dummy sink current directly to an output of switching regulator 301 of power module 105 is discussed below in connection with FIG. 13.

FIG. 13 is a flowchart of a method 1300 of a dynamic control scheme for handling a surge of current by power module 105, high-power multi-voltage system 104, and power supply controller 102 due to a sudden increase in the operation load based on prediction by adding a dummy sink current directly to an output of switching regulator 301 of power module 105 in accordance with an embodiment of the present disclosure.

Referring to FIG. 13, in conjunction with FIGS. 1, 5-9 and 11, in step 1301, task schedule controller 106 of power supply controller 102 schedules a task prior to being executed by high-power multi-voltage system 104 that only includes real load 202 (without the insertion of dummy load 201).

In step 1302, dummy sink current scheduler 601 of power supply controller 102 estimates the amount of the current change ratio using the scheduled task (see step 1301), which only includes real load 202, in order to predict the rush current case with only real load 202.

As discussed above, in one embodiment, upon checking the scheduled task, dummy sink current scheduler 601 predicts the portion in the task at which the amount of the current change ratio exceeds the threshold value, which may be user-designated, by estimating the current change ratio. In one embodiment, dummy sink current scheduler 601 also predicts the amount of the current change ratio that exceeds to the threshold value, which may be user designated, with only real load 202.

In step 1303, dummy sink current scheduler 601 of power supply controller 102 determines whether the estimated amount of the current change ratio caused by real load 202 exceeds a threshold value, which may be user-designated, within a certain period of time, which may be user-designated.

As stated above, if such a real load 202 causes the amount of the current change ratio to exceed the threshold value, which may be user-designated, within the period of time, then a predicted rush current (surge of current) to be handled by power supply controller 102, high-power multi-voltage system 104, and power module 105 may be said to occur. In one embodiment, the threshold value corresponds to the limit of the current change ratio for the switching regulator 301 (e.g., DCDC switching regulator).

If the amount of real load 202 does not cause the amount of the current change ratio to exceed the threshold value within the period of time, then, in step 1304, dummy sink current scheduler 601 of power supply controller 102 does not schedule any dummy sink current to be pulled at the output of DCDC switching regulator 301.

If, however, the amount of the current change ratio caused by real load 202 does exceed the threshold value within the period of time, then, in step 1305, dummy sink current scheduler 601 of power supply controller 102 generates and stores control signals to add a dummy sink current to the output of switching regulator 301 of power module 105 to reduce an amount of the current change ratio.

As discussed above, in one embodiment, such control signals are stored in dummy sink current scheduler 601. In one embodiment, such generation and storage of control signals to add a dummy sink current to an output of switching regulator 301 of power module 105 to reduce an amount of the current change ratio is performed when the program execution arrives at that point.

In one embodiment, dummy sink current scheduler 601 determines the timing and the amount of dummy sink current 502 to be added in power module 105 based on the extent that the amount of the current change ratio caused by real load 202 exceeds the threshold value. For example, the greater that the amount of current change ratio caused by real load 202 exceeds the threshold value, the greater the amount of dummy sink current 502 is to be added in power module 105 and the quicker that such dummy sink current 502 needs to be added. In one embodiment, the amount of dummy sink current 502 to be added in power module 105 is determined based on a correlation of the amount of dummy sink current 502 to be added in power module 105 with the amount that the current change ratio caused by real load 202 exceeds the threshold value as established by an expert. Such a correlation may be mathematically represented in a curve as established by an expert. In one embodiment, such a correlation is stored in a storage device (e.g., storage device 911, 915) of power supply controller 102.

In step 1306, dummy sink current scheduler 601 of power supply controller 102 issues such stored control signals to a controller 602 (referred to herein as the dummy sink current controller) of high-power multi-voltage system 104 at the appropriate timing (at the occurrence of the rush current) to add dummy sink current 502 to an output of switching regulator 301 of power module 105. That is, dummy sink current scheduler 601 of power supply controller 102 issues such stored current signals to dummy sink current controller 602 of high-power multi-voltage system 104 through PCI card 307 interface with the scheduling of the timing and amount of dummy sink current 502.

In one embodiment, in step 1307, dummy sink current controller 602 of high power multi-voltage system 104 issues control signals 603 to a programmable electrical (current) load 604 to add dummy sink current to an output of switching regulator 301 of power module 105. That is, dummy sink current controller 602 issues control signals 603 to a programmable electrical (current) load 604 to sink current (dummy sink current 502). In one embodiment, such control signals 603 are used to instruct programmable electrical (current) load 604 as to the timing and the amount of current (dummy sink current 502) to sink. Examples of dummy sink current controller 602 can include, but are not limited to, integrated circuits, SEA05 by ST Microelectronics®, TSM101 by ST Microelectronics®, etc.

In step 1308, programmable electrical (current) load 604 of power module 105 pulls dummy sink current 502 to avoid the rush current. That is, programmable electrical (current) load 604 of power module 105 sinks current (dummy sink current 502) based on the control signals 603 received from dummy sink current controller 602. Examples of programmable electrical (current) load 604 can include, but are not limited to, 3710A from Array, SDL1030X-E from Siglant, etc.

As an alternative to performing steps 1307-1308, steps 1309-1312 are performed as discussed below.

In one embodiment, in step 1309, dummy sink current controller 602 of high power multi-voltage system 104 issues control signals 603 to control signal generator 701 of power module 105, such as a field-effect transistor (FET) gate control signal generator, to add dummy sink current to an output of switching regulator 301 of power module 105.

In step 1310, control signal generator 701 of power module 105 converts the control signal to a gate signal of switching device 702.

In step 1311, control signal generator 701 of power module 105 issues the gate signal to switching device 702.

As discussed above, control signal generator 701 generates the voltage applied to the gate of a current-controlled switch 702, such as a field-effect transistor. In one embodiment, such first-stage control signals generated by dummy sink current controller 602 are used to instruct control signal generator 701 to generate second-stage control signals which generate dummy sink current 502 based on the voltage applied to the gate of current-controlled switch 702, such as a field-effect transistor. In one embodiment, such first-stage control signals are used to instruct control signal generator 701 to control the flow of dummy sink current 502 based on the voltage applied to the gate of current-controlled switch 702 in a manner that matches the timing and the amount of dummy sink current 502 to be added as requested by dummy sink current scheduler 601.

In one embodiment, the timing and the amount of voltage applied to the gate of current-controlled switch 702 is based on the control signals 603 received from dummy sink current controller 602, which generates the timing and the amount of dummy sink current 502 to be added as requested by dummy sink current scheduler 601. In one embodiment, the timing and the amount of voltage to be applied to the gate of current-controlled switch 702 generated by control signal generator 701 is correlated to the dummy sink current control signals 603 (issued by dummy sink current controller 602) as established by an expert. In one embodiment, such a correlation is stored in a storage device (e.g., storage device 911, 915) of power supply controller 102. Furthermore, the stored control signals are generated by dummy sink current scheduler 601 of power supply controller 102, for example, in digital format.

In step 1312, switching device 702 (e.g., current-controlled switch) pulls the dummy sink current to avoid the rush current in power module 105.

An illustration of reducing the amount of current change ratio with dummy sink current is shown in FIG. 8.

As shown in FIG. 8, FIG. 8 is a graph 800 of the load amount (along the Y-axis) versus time (along the X-axis) in which the added dummy sink current 502 reduces the amount of the current change ratio before the sudden increase in the operation load which occurs at the time of processing the suddenly increased real operation load 202 due to having the load current 203 (I_{comp_load}) for the compensated load (with the additional dummy sink current) increase in a steady manner so as to reduce the amount of the current change ratio before processing the suddenly increased real operation load 202 as shown in FIG. 8. For example, as shown in FIG. 8, load current 501 (I_{real_load}) for real load 202 significantly rises; however, by utilizing dummy sink current 502 (I_{dummy_sink}), compensated load current 203 (I_{comp_load}) with the additional dummy sink current 502 rises in a more smooth manner effectively reducing the amount of the current change ratio before processing the suddenly increased real operation load 202.

Upon executing steps 1308 and 1312, in step 1313, task schedule controller 106 of power supply controller 102 determines if there are additional tasks to be scheduled.

If there are no more additional tasks to be scheduled, then, in step 1314, task schedule controller 106 of power supply controller 102 completes the execution of method 1300.

If, however, there are additional tasks to be scheduled, then, in step 1315, task schedule controller 106 of power supply controller 102 selects the next task to be scheduled. Upon selecting the next task to be scheduled, task schedule controller 106 of power supply controller 102 schedules the next selected task prior to being executed by high-power multi-voltage system 104 that only includes real load 202 (without the insertion of dummy load 201) in step 1301.

As a result of the foregoing, the rush current may now be handled by a power supply controller, a high-power multi-voltage system, and a power module by adding a dummy load into the program memory of the high-power multi-voltage system or by adding a dummy sink current directly to an output of a switching regulator (e.g., DCDC switching regulator) of the power module to reduce the amount of the current change ratio prior to the sudden increase in the operation load. The reduction of the amount of the current change ratio is accomplished without system latency degradation (i.e., without delaying and reducing the load but instead by imposing an additional dummy load or dummy sink current).

Furthermore, the principles of the present disclosure improve the technology or technical field involving power supply systems.

As discussed above, power supply systems may include a power module which provides the physical containment for several power components, such as switching regulators (e.g., DCDC switching regulators) and low-dropout (LDO) regulators. A switching regulator, such as a DCDC switching regulator, converts input direct current (DC) voltage to the desired direct current (DC) voltage. A LDO regulator is a DC linear voltage regulator that regulates the output voltage even when the input voltage is very close to the output voltage. Multiple regulators, such as switching regulators and LDO regulators, may be placed close to the processor chips or modules in order to meet the processor's requirement (e.g., low noise margin, high rush current, etc.) for point of load (POL). Point of load (POL) power supplies solve the challenge of high peak current demands and low noise margins required by high-performance semiconductors, such as microcontrollers or ASICs, by placing individual power supply regulators (linear or DCDC) close to their point of use. In order to implement a large current power supply system to supply power to a high-power multi-voltage system, the power module of the power supply system needs to utilize multiple regulators, such as the regulators discussed above, in order to implement POL for power distribution, save space for multiple power supplies and enable system portability. In certain situations, the power module of the power supply system needs to handle a surge of current (referred to herein as the “rush current”) due to a sudden increase in operation load, such as a sudden increase in the load exhibited by the high-power multi-voltage system. Such a surge of current may not be able to be handled by only the power module. For example, the de-coupling capacitor (capacitor used to decouple one part of a circuit from another) may not be able to maintain the correct voltage level to power the load. Furthermore, rush current may cause a malfunction in the power module, such as with the switching regulators (e.g., DCDC switching regulators) due to the saturation of the inductors or the destruction of the power switches. Furthermore, the malfunction of the switching regulators (e.g., DCDC switching regulators) may then cause operation problems for the LDO regulators due to having their input voltage and current supplied by such switching regulators. Unfortunately, there is not currently a means for effectively handling such surges of current (rush currents) by the power module due to a sudden increase in operation load.

Embodiments of the present disclosure improve such technology by scheduling a task to be executed, where the task only includes a real load. Before executing the task, it is determined if the amount of the real load may cause the amount of the current change ratio in a power module to exceed a threshold value, which may be predicted within a certain length of the task process. A current change ratio, as used herein, refers to the ratio of the current before and after a predicted rush current. If the amount of the real load alone is predicted to cause the amount of the current change ratio to exceed the threshold value (rush current case), then the predicted rush current (surge of current) is handled by the power supply controller, the high-power multi-voltage system, and the power supply module (or the power supply system). In response to predicting a potential surge of current (rush current), a dummy load code is added into the program memory in the high-power multi-voltage system or a dummy sink current is added to an output of the switching regulator of the power module in order to avoid the rush current (surge of current case). By adding a dummy load or a dummy sink current, the current of the switching regulator is increased gradually and smoothly so as to avoid the rush current (surge of current) case. In this manner, the rush current may now be handled by the power controller, high-power multi-voltage system, and power module by reducing the amount of the current change ratio prior to the sudden increase in the operation load. Furthermore, in this manner, there is an improvement in the technical field involving power supply systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for handling a surge of current due to a sudden increase in operation load, the method comprising:
scheduling a task to be executed, wherein said task comprises a real load; and
adding a dummy load in a high-power multi-voltage system or a dummy sink current to an output of a switching regulator of a power module to reduce an amount of a current change ratio in response to said executed task indicating an amount of said current change ratio exceeding a threshold value within a period of time.

2. The method as recited in claim 1 further comprising:
generating code to include both said real load and a dummy load.

3. The method as recited in claim 2, wherein said code is executed so that compensated current which includes current for both said real load and said dummy load is pulled from said output of said switching regulator of said power module.

4. The method as recited in claim 1, wherein said switching regulator comprises a DCDC switching regulator.

5. The method as recited in claim 1 further comprising:
generating control signals to add said dummy sink current to said output of said switching regulator of said power module.

6. The method as recited in claim 5, wherein said control signals are used to instruct a programmable electrical load to pull said dummy sink current from said output of said switching regulator of said power module to reduce said amount of said current change ratio.

7. The method as recited in claim 5, wherein said control signals are used to instruct a switching device to pull said dummy sink current from said output of said switching regulator of said power module to reduce said amount of said current change ratio.

8. A computer program product for handling a surge of current by a power module due to a sudden increase in operation load, the computer program product comprising one or more computer readable storage mediums having program code embodied therewith, the program code comprising programming instructions for:
scheduling a task to be executed, wherein said task comprises a real load; and
adding a dummy load in a high-power multi-voltage system or a dummy sink current to an output of a switching regulator of a power module to reduce an amount of a current change ratio in response to said executed task indicating an amount of said current change ratio exceeding a threshold value within a period of time.

9. The computer program product as recited in claim 8, wherein the program code further comprises the programming instructions for:
generating code to include both said real load and a dummy load.

10. The computer program product as recited in claim 9, wherein said code is executed so that compensated current which includes current for both said real load and said dummy load is pulled from said output of said switching regulator of said power module.

11. The computer program product as recited in claim 8, wherein said switching regulator comprises a DCDC switching regulator.

12. The computer program product as recited in claim 8, wherein the program code further comprises the programming instructions for:
generating control signals to add said dummy sink current to said output of said switching regulator of said power module.

13. The computer program product as recited in claim 12, wherein said control signals are used to instruct a programmable electrical load to pull said dummy sink current from said output of said switching regulator of said power module to reduce said amount of said current change ratio.

14. The computer program product as recited in claim 12, wherein said control signals are used to instruct a switching device to pull said dummy sink current from said output of said switching regulator of said power module to reduce said amount of said current change ratio.

15. A system, comprising:
a memory for storing a computer program for handling a surge of current by a power module due to a sudden increase in operation load; and
a processor connected to said memory, wherein said processor is configured to execute program instructions of the computer program comprising:
scheduling a task to be executed, wherein said task comprises a real load; and
adding a dummy load in a high-power multi-voltage system or a dummy sink current to an output of a switching regulator of a power module to reduce an amount of a current change ratio in response to said executed task indicating an amount of said current change ratio exceeding a threshold value within a period of time.

16. The system as recited in claim 15, wherein the program instructions of the computer program further comprise:
generating code to include both said real load and a dummy load.

17. The system as recited in claim 16, wherein said code is executed so that compensated current which includes current for both said real load and said dummy load is pulled from said output of said switching regulator of said power module.

18. The system as recited in claim 15, wherein said switching regulator comprises a DCDC switching regulator.

19. The system as recited in claim 15, wherein the program instructions of the computer program further comprise:
generating control signals to add said dummy sink current to said output of said switching regulator of said power module.

20. The system as recited in claim 19, wherein said control signals are used to instruct a programmable electrical load or a switching device to pull said dummy sink current from said output of said switching regulator of said power module to reduce said amount of said current change ratio.
